(19) United States
(12) Patent Application Publication
(10) Pub. No.: US 2009/0030853 A1
(43) Pub. Date: Jan. 29, 2009

(54) SYSTEM AND A METHOD OF PROFITING OR GENERATING INCOME FROM THE BUILT-IN EQUITY IN REAL ESTATE ASSETS OR ANY OTHER FORM OF ILLIQUID ASSET

(76) Inventor: Alain L. De La Motte, Hillsboro, OR (US)

Correspondence Address: KOLISCH HARTWELL, P.C., 200 PACIFIC BUILDING, 520 SW YAMHILL STREET, PORTLAND, OR, 97204, US

(21) Appl. No.: 12/057,684

(22) Filed: Mar. 28, 2008

Related U.S. Application Data
(60) Provisional application No. 60/909,208, filed on Mar. 30, 2007.

(51) Int. Cl. G06Q 40/00

(52) U.S. Cl. 705/36 R; 705/35; 705/37

(57) ABSTRACT

Briefly, embodiments of a system or a method of profiting or generating income from equity in real estate or any other form of illiquid asset is disclosed.

### CROSS-REFERENCE TO RELATED APPLICATIONS

This application claims priority to U.S. Provisional Patent Application Ser. No. 60/909,208 filed Mar. 30, 2007, and entitled “System and Method of Banking Trust”, the disclosure of which is herein incorporated by reference.

Also incorporated by reference in their entirety are the following co-pending non-provisional patent applications: (1) U.S. patent application Ser. No. 11/058,750, filed Feb. 14, 2005 and entitled “System and Method for High-Yield Returns in Riskless-Principal Interest Rate/Yield Arbitrage”; (2) U.S. patent application Ser. No. 11/111,503, filed Apr. 20, 2005 and entitled “System and Method for High-Yield Investment Returns in Riskless-Principal Interest Rate/Yield Arbitrage; (3) U.S. patent application Ser. No. 11/754,287, filed May 26, 2007 and entitled “A Revenue-Producing Bank Card System & Method Providing the Functionality & Protection of Trust Connected Banking”; (4) U.S. patent application Ser. No. 11/764,175, filed Jun. 15, 2007 and entitled “Global Fiduciary-Based Financial System for Yield & Interest Rate Arbitrage” (5) U.S. Non-Provisional patent application Ser. No. 11/832,645, filed Aug. 1, 2007 and entitled System And Method For Executing Secure Exchange Transactions; (6) U.S. Provisional Patent Application Ser. No. 60/859,300, filed Nov. 14, 2006 and entitled A Riskless-Principal Investment Method For High-Yield Profits Executed Through A Trust-Managed Hedge Fund; and (7) U.S. Provisional Patent Application Ser. No. 60/876,710, filed Dec. 22, 2006 and entitled A Method of Investment in Fixed Income Products.

### TECHNICAL FIELD

This disclosure relates to investment techniques to generate income from illiquid assets.

### BACKGROUND

Owner occupied homes have long been considered the “investment choice” to build household wealth over time. Many have also chosen other real estate investments, directly and/or through participant ownership (limited partnerships, REITs, etc.) as a means of further wealth accumulation. According to a 2004 Real Estate Roundtable report, owner occupied homes were worth in excess of $15.2 Trillion, with the equity portion valued at approximately $8 Trillion; further, this $8 Trillion represented 32% of US household wealth, but illiquid wealth.

In addition, commercial real estate was worth approximately $5 trillion (including 4 billion sf of office space; 13 billion sf of industrial property; almost 6 billion sf of shopping center space; 4.4 million hotel rooms; and 33 million sf. of rental apartment space.) Assuming that 50% of the commercial real estate value is equity, for example, this suggests a total of more than $10 Trillion in US real estate equity alone that is dormant and not generating an additional return for the owner.

Other than “holding” real estate and hoping for continuing inflationary increases in the value of real estate property, historically there has been essentially three (3) ways to enhance return on an owner's illiquid equity. Unfortunately, these approaches have also placed the monetized equity or principal “at risk.”

### DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description, if read with the accompanying drawings, in which:

FIG. 1 is a schematic overview diagram illustrating an embodiment of a unit participation trust in which illiquid assets are employed to generate income or profits.

FIG. 2 is a schematic diagram illustrating an embodiment of a process for establishing value of an illiquid asset.

FIG. 3 is a schematic diagram illustrating an embodiment of a process of transferring value to a trust, such as the trust embodiment of FIG. 1.

FIG. 4 is a schematic diagram illustrating an embodiment of a process of using a pool of illiquid assets to generate liquid funds, such as for investment.

FIG. 5 is a schematic diagram of an embodiment of a process in which trust assets are to be invested.

FIG. 6 is a schematic diagram that illustrates an embodiment of a process in which a principal-protected investment is accomplished via matched-trade arbitrage in fixed income products.

FIG. 7 is a schematic diagram illustrating an embodiment in which priorities are provided with respect to liquidation of assets of the trust in the event of a default.

FIG. 8 is a schematic diagram illustrating an embodiment of a process by which trust dividends are used to retire a unit holders' first mortgages early.

FIG. 9 is a schematic diagram illustrating another embodiment, in which, for this particular embodiment a mortgage originator is able to profit from making loans and receiving trust dividends.

FIG. 10 is a schematic flow diagram of an embodiment of a process, corresponding to the information shown in FIGS. 11-13, in which a specific example is calculated to demonstrate generating an arbitrage profit using illustrative transaction parameters and closing conditions.

FIGS. 11-13 provide data for a specific example of the embodiment of FIG. 10 in which an arbitrage profit is generated using illustrative transaction parameters and closing condition

### DESCRIPTION OF THE PREFERRED EMBODIMENT

In the following detailed description, numerous specific details are set forth to provide a thorough understanding of claimed subject matter. However, it will be understood by those skilled in the art that claimed subject matter may be practiced without these specific details. In other instances, well-known methods, procedures and/or other aspects have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” and/or “an embodiment” in various places throughout this specification are not necessarily intended to refer to the same embodiment or to any one particular embodiment described. Furthermore, it is to be understood that particular features, structures, and/or characteristics described may be combined in various ways in one or more embodiments. In general, of course, these and other issues may vary with the particular context. Therefore, the particular context of the description and the usage of these terms may provide helpful guidance regarding inferences to be drawn for that particular context.

Likewise, the terms, “and,” “or,” and “and/or” as used herein may include a variety of meanings that will depend at least in part upon the context in which it is used. Typically, “and/or” if used to associate a list, such as A, B and/or C, is intended to mean A, B, or C as well as A, B and C. Though, it should be noted that this is merely an illustrative example and claimed subject matter is not limited to this example.

Unless specifically stated otherwise, throughout this specification, terms such as “processing,” “computing,” “calculating,” “selecting,” “forming,” “enabling,” “inhibiting,” “identifying,” “initiating,” “querying,” “obtaining,” “hosting,” “maintaining,” “representing,” “modifying,” “receiving,” “transmitting,” “storing,” “authenticating,” “authorizing,” “hosting,” “determining” and/or the like refer to actions and/or processes that may be performed by a system, such as a computer and/or other computing platform, capable of manipulating and/or transforming data which may be represented as electronic, magnetic and/or other physical quantities within the system's processors, memories, registers, and/or other information storage, transmission, reception and/or display devices. Accordingly, a computing platform refers to a system or a device that includes the ability to process and/or store data in the form of signals. Thus, a computing platform, in this context, may comprise hardware, software, firmware and/or any combination thereof. Further, unless specifically stated otherwise, a process as described herein, with reference to flow diagrams or otherwise, may also be executed and/or controlled, in whole or in part, by a computing platform.

It is noted that particular embodiments of the use of principal-protected investment techniques are described herein as a method to extract a profit from illiquid assets for the purpose of either producing income for the owner or to facilitate the retirement of a debt obligation well before its initial planned maturity date, for example. However, these embodiments are merely intended as illustrative examples and claimed subject matter is not intended to be limited in scope to these examples or embodiments. For example, one embodiment may combine a fiduciary structure involving unit participation trusts which may also be combined with a proprietary investment technology process to derive value from a dormant/illiquid asset. Such assets may including any of the following asset classes: equity held in real estate properties, gold bullions deposit certificates, bank instruments; debt instruments; option contracts; commodity contracts, derivative instruments, commodities, mining assets (operating and non-operating), mineral reserve deposits, guaranteed investment contracts, intellectual property patents, masters' paintings, valuable jewelry; precious stones; trade receivables, freely tradable public company stocks, restricted stocks of public companies, bonds, notes, life insurance policies, portfolios of life settlement policies, transportation equipment; marine crafts; contracts of any form between credit-worthy counterparties that provide for a pre-determined future cash flow to the beneficiary that can be converted to a present value for appraisal purposes, any other form and type of valuable asset which can be appraised and certified by an independent appraiser and where a lien or other form of security interest can be satisfied; and more.

One feature of an embodiment relates to the use of a Unit Participation Trust to hold such assets, although claimed subject matter is not limited in scope to such an embodiment. Many investment professionals, for example, have forecasted that returns from traditional asset classes, such as stock equities, will not be as high over the next decade. Similarly, real estate has seen a significant decline in valuation increases. There are many investors holding illiquid interest in real estate, intellectual property, minerals, art, insurance (term, whole life, & life settlements), as well as stocks and bonds with which they cannot or do not wish to part with. Whether the asset is illiquid by choice or out of necessity, contribution of an illiquid asset to a Unit Participation Trust, as described in more detail hereinafter, such as for this particular embodiment, offers asset owners an opportunity to enhance returns on illiquid assets via strategies in principal protected investments. An application of this opportunity may be demonstrated in real estate equity, although, of course, claimed subject matter is not limited in scope to real estate equity.

Owner occupied homes have long been considered the “investment choice” to build household wealth over time. Many have also chosen other real estate investments, directly and/or through participant ownership (limited partnerships, REITs, etc.) as a means of further wealth accumulation. According to a 2004 Real Estate Roundtable report, owner occupied homes were worth in excess of $15.2 Trillion, with the equity portion valued at approximately $8 Trillion; further, this $8 Trillion represented 32% of US household wealth, but illiquid wealth.

In addition, commercial real estate was worth approximately $5 trillion (including 4 billion sf of office space; 13 billion sf of industrial property; almost 6 billion sf of shopping center space; 4.4 million hotel rooms; and 33 million sf. of rental apartment space.) Assuming that 50% of the commercial real estate value is equity, for example, this suggests a total of more than $10 Trillion in US real estate equity alone that is dormant and not generating an additional return for the owner.

Other than “holding” real estate and hoping for continuing inflationary increases in the value of real estate property, historically there has been essentially three (3) ways to enhance return on an owner's illiquid equity. Unfortunately, these approaches have also placed the monetized equity or principal “at risk.”
Sell the real estate and re-invest the accumulated equity in another real estate property, along with the “risks” of higher interest rates, slower valuation growth, and/or limited re-investment opportunities due to “hot real estate markets,” flush capital markets, or both.
Convert the equity into cash either through a second mortgage (with the attendant financing costs) or home equity line and re-invest cash proceeds in real estate (individually or as a participant) or other traditional investments such as stocks and bonds, all with their individual inherent risks; in each instance, needing to have returns on the chosen investment/s to exceed the financing costs and annual interest payments plus meet or exceed the forgone economic return on continuing to hold equity in an illiquid state.
Reverse mortgages for those 62+ are another option, but several factors including local lending limits, the potential of declining RE values, existing 1^{st} mortgages, and service fee “set asides” have made this a less than attractive option. Furthermore, those who exercise the reverse mortgage option forego the contribution of a large portion of their household wealth to their estate

In summary, the risks of attempting to enhance return on equity are:
The cost of converting the illiquid asset into cash so that the proceeds can be invested.
The ability of the investor to produce a return on investment that exceeds the cost of money while not incurring a risk of capital loss. The nature of this risk may explain why so much real estate equity stays illiquid.

However, as described in more detail hereinafter, in one particular embodiment, as simply an example, a Real Equity Unit Participation Trust (the “Trust”) may offer investors (individual consumers, REITS, corporations and real estate investors) with illiquid equity in commercial and residential real estate a technique to put that equity to work 1) without significant risk to the principal (the equity) and 2) where it is reasonably likely that investment returns will exceed cost of borrowings.

In such an embodiment, the Trust may, for example, employ financial engineering investment strategies to:
Aggregate illiquid real estate assets
Monetize (or make liquid) those assets through a secured lending process
Invest liquidity obtained from intra-day loans
Adopt “permitted investment” rules implemented through a fiduciary trustee that avoid or reduce instances in which the principal investment capital is put at risk
Generate returns which exceed the interest rate paid for the loans
Produce trust dividends for trust unit holders which they may use to retire a first mortgage earlier than planned or to create a new-found steady source of income or cash flow.
   As will be clear from this example embodiment, such investment strategies reduce downside risk while producing above average returns on investment.

Although claimed subject matter is not limited in scope in this respect, for this example, “Permitted Investments” may comprise at least five elements which, if executed in tandem, for example, are expected to produce above average returns for the trust with little or no risk of loss of principal. Likewise, the returns on investment are expected to exceed the cost of monetizing illiquid assets. For example, in this embodiment, this may be accomplished by
Monetizing illiquid assets through a secured trading facility line with an intra-day drawdown occurring if a trade is anticipated to occur;
Intra-day, “principal-protected¹” fixed income buy-sell transactions commonly referred to as “Matched Trades²” wherein the profitability of a trade is reasonably likely;
Fixed income instruments purchased as “buy-and-hold” as part of a gains trading strategy, wherein the downside risk is hedged and the upside maintained;
Overnight repo & reverse repo, in which the funds are swept overnight, under contract, to a major financial institution, and returned the next morning with the pre-agreed, contracted Fee/s for the use of the funds;
A securities lending strategy to increase the aggregate yield to maturity of the portfolio of instruments. ¹In this context, a situation in which one party enters into a transaction and thereafter or contemporaneously enters into an offsetting transaction so that the risk or payments under the transactions net out.” See, for example, US House of Representatives, Currency Committee on Banking and Financial Services²In this context, “Matched Trade” means a transaction where the following conditions are met: (a) a financial instrument is pre-sold before it is purchased; (b) settlement risk is reduced through some form of commitment of payment against delivery, and (c) the all-inclusive price of resale is greater than that paid for such instrument.

In this particular embodiment, a Trust Agreement for the Trust governs the activities of a Trustee, for the benefit of trust beneficiaries, according to the permitted investment guidelines mandated within the Agreement. Imbedded in the Trust Agreement are the “permitted investment guidelines,” which reflect, for this particular embodiment, investment strategies, such as those noted above.

Thus, for this particular embodiment, contributors of real estate equity may contribute their illiquid assets to the Trust in exchange for Trust Preferred Variable Rate Notes (Notes) issued by the Trustee and thereby become Beneficial Owners of Trust Corpus. It is anticipated that such Trust Notes will be beneficially rated. For example, a rating may be based at least in part on:
Return on Investments are capped and comprise dividends primarily
There is no interest paid on the Assets held in Trust
The “permitted investment guidelines” in the Trust Agreement reduce instances of the principal being put at risk

For purposes of illustration only, a simply working example is provided here. Assume that a homeowner has a home appraised at $800,000, an existing $500,000 mortgage, on which a little over 5 years of payments have been made. The following operations describe conversion of illiquid equity to liquidity and an attendant investment process.
Owner/Investor transfers $300,000 of illiquid equity in the home (in the form of a deed of trust) and receives 1 unit of the Trust for every $1.00 of equity).
Loans obtained by the Trust for investment purposes do not in general create a risk of foreclosure for the home owner, in that Trust principal is secured by: (a) an asset pool of the Trust (equity in real estate assets); (b) investment profits; and (c) optionally if desired, a principal guarantee issued by an insurance company (rated AAA by S&P) that may commit to loan principal repayment.
Owner/Investor receives an irrevocable option to put the Trust note to the Trust at the end of any calendar month if dividends are below a pre-determined threshold. Retirement of the note releases the 2^{nd} mortgage of the Trust on the property and pays out undistributed dividends due on the Note.
Owner/Investor is able to retire a 30 year mortgage in 12 and earn $820,458 on a $300,000 illiquid asset during that period: save 151 monthly payments of $2,997.75 ($452,660)+earn $367,797 in dividends.
In case the home owner desires liquidity at some time, the Trust note can be pledged to a third party lender to obtain a third party loan. In the event the fund is traded as an Exchange Traded Fund, liquidity will be available through stock market trading activities. In any case, a Trust Preferred Security constitutes an instrument that is discountable at the Federal Reserve Bank's New York discount window at for from 70% to 94% of the face amount of the instrument.

### Typical Application Example

| Appraised Home Value | | $800,000 |
|---|---|---|
| First Mortgage | | $500,000 |
| | Remaining Principal Balance Due | $463,248 |
| | Term | 30 Years/360 Months |
| | Interest Rate | 6% p.a. |
| | Monthly Payments (interest & principal) | $2,997.75 |
| | First Mortgage Closing | June, 2001 |
| | Month Elapsed | 63^{rd} Month |
| | Next Monthly Payment | 64^{th} Installment |
| Second Mortgage | | $----0---- |
| Net Equity (Deed of Trust) Exchanged for | | $300,000 |
| a Trust Note | | |
| | Date of Equity contribution | Oct. 7, 2006 |
| | First Monthly Dividend Due | Nov. 30, 2006 |
| Loan to Value Invested (80%) | | $240,000 |
| | Average Return on Investment | 12% p.a. |
| | Trust Dividends applied to 1^{st} Mortgage | $2,400/mth |
| | 30 Year Mortgage Retired in | 2013 instead of 2031 |

| | |
|---|---|
| Value of Enhanced benefits (over actual | $820,458 |
| Life - 12 years) | |
| Mortgage Retired | 18 years earlier |

In one embodiment, therefore, a method of forming a standardized trust structure is provided that may include forming a trust, such as by an agreement, with the trust including an aggregated liquidity pool, and constructing a trust agreement to allow the trust to perform pre-selected functions. The method embodiment may further include establishing a system of issuing and redeeming fractional units of ownership in the trust, creating trust sub-accounts to receive cash and non-cash deposits, and opening and maintaining a master custody account for the trust. Likewise, the method embodiment may also include issuing trust units to new depositors in exchange for cash and non-cash assets contributed to the trust, adopting permitted investment rules for the aggregated liquidity pool of the trust, obtaining a secured loan facility secured by non-cash assets held in the trust; and distributing trust dividends to unit holders.

Likewise, in another embodiment, a system of forming a standardized trust structure is provided that may include a trust with an aggregated liquidity pool, and a trust agreement that may allow the trust to perform pre-selected functions. The system embodiment may further include a subsystem of issuing and redeeming fractional units of ownership in the trust, trust sub-accounts to receive cash and non-cash deposits, and a master custody account for the trust. Likewise, the system embodiment may also further involve a subsystem for issuing trust units to new depositors in exchange for cash and non-cash assets contributed to the trust, a set of permitted investment rules for the aggregated liquidity pool of the trust, and a secured loan facility secured by non-cash assets held in the trust; and distributing trust dividends to unit holders.

In yet another embodiment, a method of forming an investment engine may be provided for use within a standardized trust structure. Such an embodiment may include constructing and implementing a principal-protected investment mechanism.

Likewise, an example of an embodiment may be viewed as an investment engine for use within a standardized trust structure, in which the embodiment includes a principal-protected investment mechanism.

Still another embodiment may include a method of adopting an investment strategy that complies with permitted investment rules of a trust so as to reduce risk and increase return on an investment. A method embodiment may include, for example, considering plural sub-strategies that include arbitrage trading strategies, overnight sweep strategies, risk mitigation strategies and profit generating strategies. For example, trade execution, credit and liquidity risks in arbitrage trading strategies may be reduced. Additionally, some embodiments may include applying financial leverage to increase profitability, applying refinancing techniques involving repo and reverse repo strategies, collateralization and risk management strategies; and including plural sub-strategies in refinancing/investment strategies.

Still one more embodiment may include a system for adopting and using an investment strategy that complies with permitted investment rules of a trust and simultaneously so as to reduce risk and increase return on an investment. Again, an embodiment may include plural sub-strategies that include arbitrage trading strategies, overnight sweep strategies, risk mitigation strategies and profit generation strategies, as well as reducing trade execution, credit and liquidity risks in arbitrage trading strategies. Additionally, a particular system embodiment may include financial leverage to increase profitability, refinancing techniques involving repo and reverse repo strategies, collateralization and risk management strategies; and include plural sub-strategies in an investment strategy.

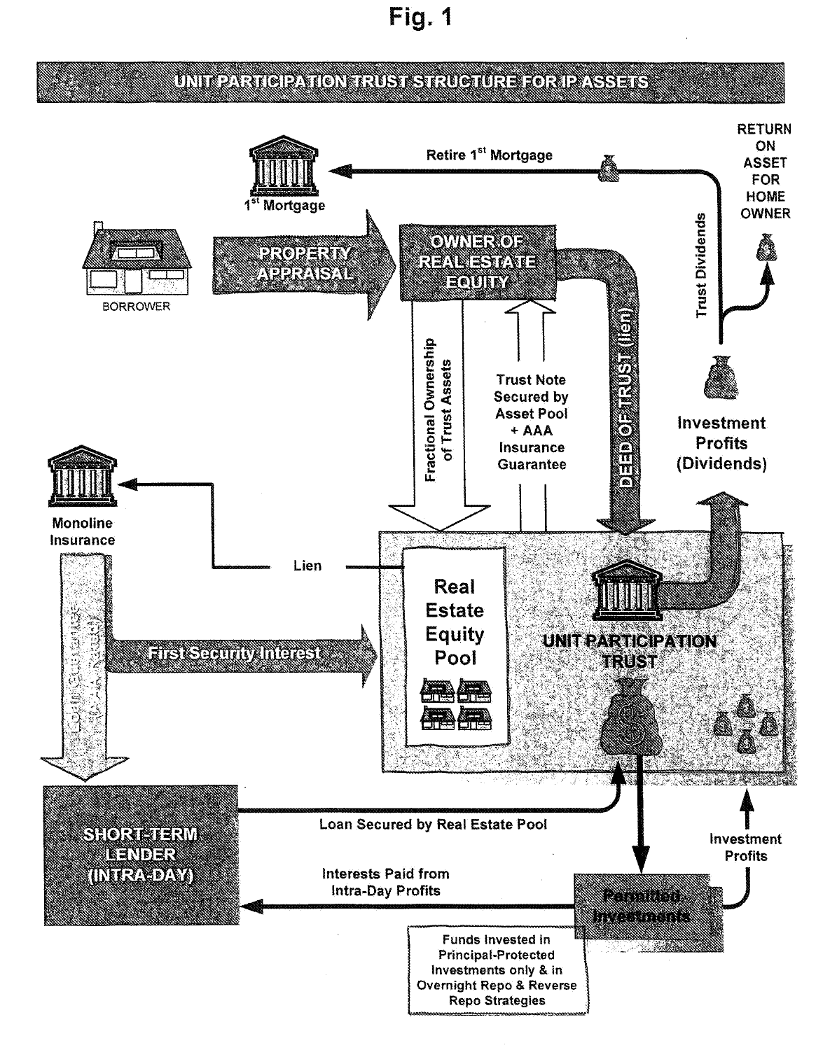

Referring to FIGS. 1-8, an embodiment of a method of forming a trust structure, such as a Unit Participation Trust is depicted in FIG. 1. It is noted that in this context, the term “trust” or “trust structure” in specifically intended to include legal arrangements that have trust-like properties, such as those described in more detail below. As will be noted further below, embodiments in accordance with claimed subject matter may have several aspects. Likewise, embodiments include systems as well. To implement any and all of the to-be-described embodiment details, it is presently planned to utilize, where appropriate, suitable software, firmware or hardware technology, as well as suitable electronic or telemetric communication technologies. Also, to the extent communication devices/mechanisms are referred to below, any suitable combination of software, firmware or hardware may be used, as well as conventional communication devices (e.g. a PDA, a phone, a computer).

It will also be understood from the description below that embodiments of claimed subject matter are by no means limited to particular timing/ordering arrangement that may be described below.

### Forming a Trust Structure.

In one embodiment, therefore, a method of forming a standardized trust structure is provided that may include forming a trust, such as by an agreement, with the trust including an aggregated liquidity pool, and constructing a trust agreement to allow the trust to perform pre-selected functions. The method embodiment may further include establishing a system of issuing and redeeming fractional units of ownership in the trust, creating trust sub-accounts to receive cash and non-cash deposits, and opening and maintaining a master custody account for the trust. Likewise, the method embodiment may also include issuing trust units to new depositors in exchange for cash and non-cash assets contributed to the trust, adopting permitted investment rules for the aggregated liquidity pool of the trust, obtaining a secured loan facility secured by non-cash assets held in the trust; and distributing trust dividends to unit holders.

With respect to forming the trust structure, forming in one embodiment may involve determining if the trust is to be a stand alone trust, a master trust or a sub-trust of a master trust, appointing a fiduciary trustee to act as trustee of the trust, or licensing plural grantors (e.g. an employer who sponsors a trust for the benefit of its employees or an affinity group for the benefit of its members) to form their own sub-trusts of a master trust.

Forming in this context may also involve forming a unit participation trust authorized by a statute such as the state law of a state in the U.S or the laws of any jurisdiction around the world where trust laws exist. That trust, in such an embodiment, for example, may be formed by executing a trust agreement between the trustee and plural grantors who may make a nominal contribution to the initial trust corpus to form the trust. Forming may also include incorporating the trust with government authorities and receiving in return a certificate of trust.

Forming may also involve appointing an institutional custodian to provide trust custody services, and plural independent third-party service providers or agents to provide services to the trust. For example, those services may be provided by the following personnel: asset managers, registrar, issuing agent, transfer agent, paying agent, exchange rate agent, calculation agent, facility agent, investment rule validation agent, etc.

In a different embodiment, forming may also involve forming a structured-finance architecture with a bankruptcy-remote special purpose company designed to accommodate plural stockholders; a trust indenture; a trustee; and a custodian. The special purpose company may, in such an embodiment, issue callable notes or debentures which may be called at any time and in any fractional amount. Likewise, an option to call may be revolving so as to give birth to a new call option if a call is made by withdrawing cash from the stockholder's account.

An architecture in some embodiments may also be constructed to provide a revenue-producing debit card to end users. Forming also may involve forming a variety of structures, including a mutual fund, a mutual banking institution, a unit participation fund or any form of a unit trust.

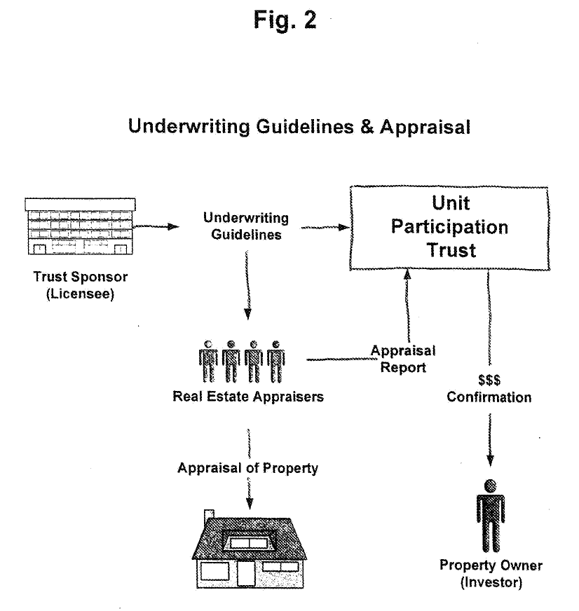

FIGS. 2-8 are described in more detail below to provide an aid in understanding embodiments of claimed subject matter. However, it is intended that the scope of claimed subject matter not be limited to these examples. These descriptions are intended to be illustrative and many other specific embodiments are possible while remaining within the scope of claimed subject matter.

FIG. 2 describes an embodiment of a process for establishing value of an illiquid asset. In this example, a home is to be appraised by an independent appraiser for the purpose of establishing a value, based on pre-established underwriting guidelines, at which a particular real estate asset will be accepted in a trust such as that depicted in FIG. 1. That value for this particular example establishes the number of trust units the home owner will receive.

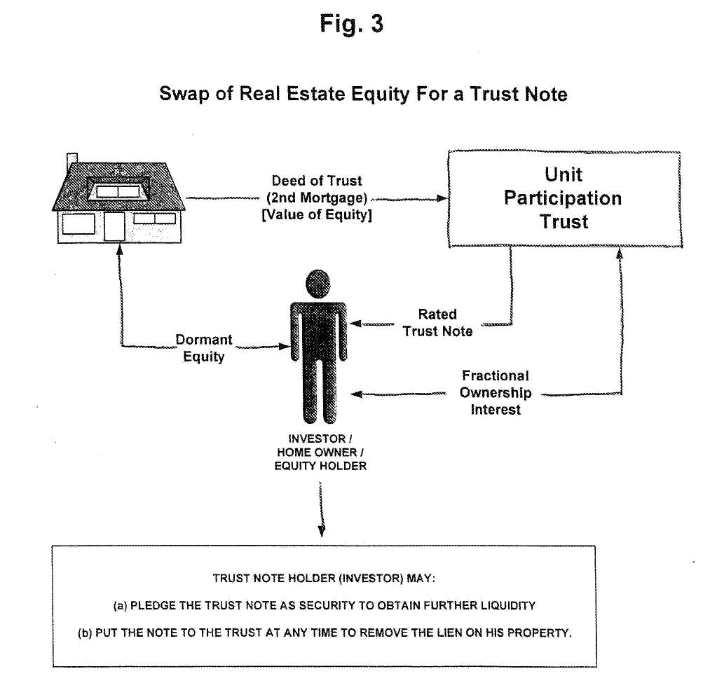

FIG. 3 describes an embodiment of a process of transferring value to a trust, such as the trust embodiment of FIG. 1. Here, specifically, in this example, a deed of trust is swapped which transfers the value of the equity owned in the home to the trust. In this case, the homeowner delivers a duly executed deed of trust to the trust and receives in exchange, as consideration, a trust preferred note security which gives him a fractional unit ownership interest in the trust for the face value of the note.

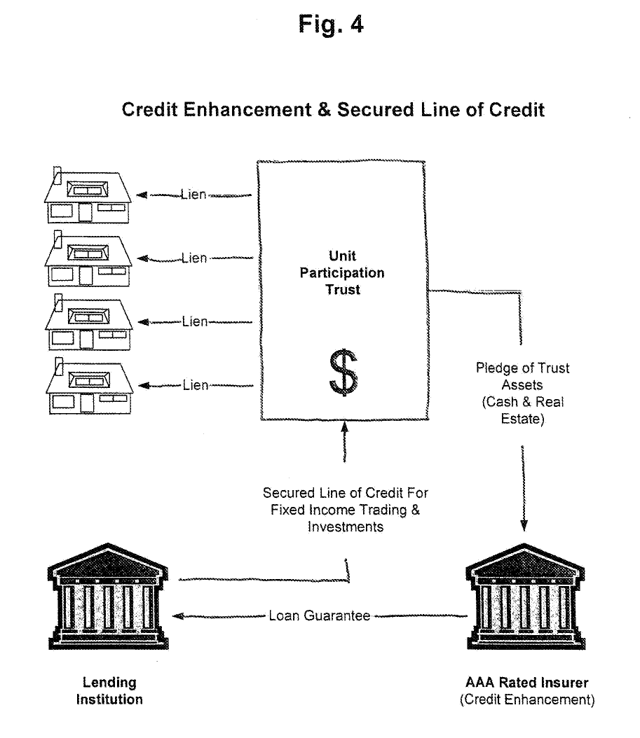

FIG. 4 illustrates an embodiment of a process of using a pool of illiquid assets to generate liquid funds, such as for investment. Here, this embodiment includes perfecting the liens on trust assets (equity in a pool of homes) and using that pool of asset to secure a loan that provides cash that can then be invested. This diagram refers to the use of a credit enhancement instrument that may be utilized in some embodiments. This instrument may, for example, be issued by a third-party insurance guarantee provider (also referred to as a guarantor) wherein the guarantor is the first line of recourse in the event of a default. However, alternately, a lender may make a secured loan directly to the trust (thus bypassing the guarantor) whereupon the asset pool will be pledged directly to the lender and not to the guarantor. Again, these are merely examples.

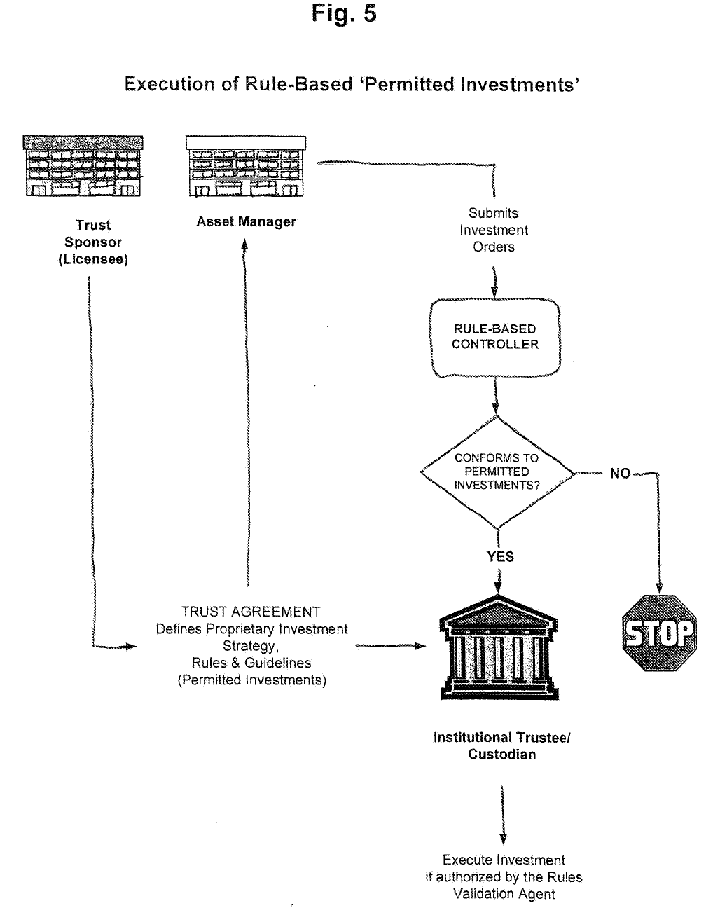

FIG. 5 illustrates an embodiment of a process in which trust assets are to be invested. For this particular embodiment, a trust sponsor (also referred to as a grantor) may define rules that are applicable to investments of trust assets and these rules may be converted into language that is incorporated in the trust agreement. The diagram also illustrates an embodiment in which investment decisions are to be filtered through an electronic or manual rule-based controller that is managed and operated by a rules validation agent (e.g., as an agency service provided to the trust) before the trustee is authorized to execute an order received from an asset manager who has been authorized to invest trust funds in accordance with permitted investment rules.

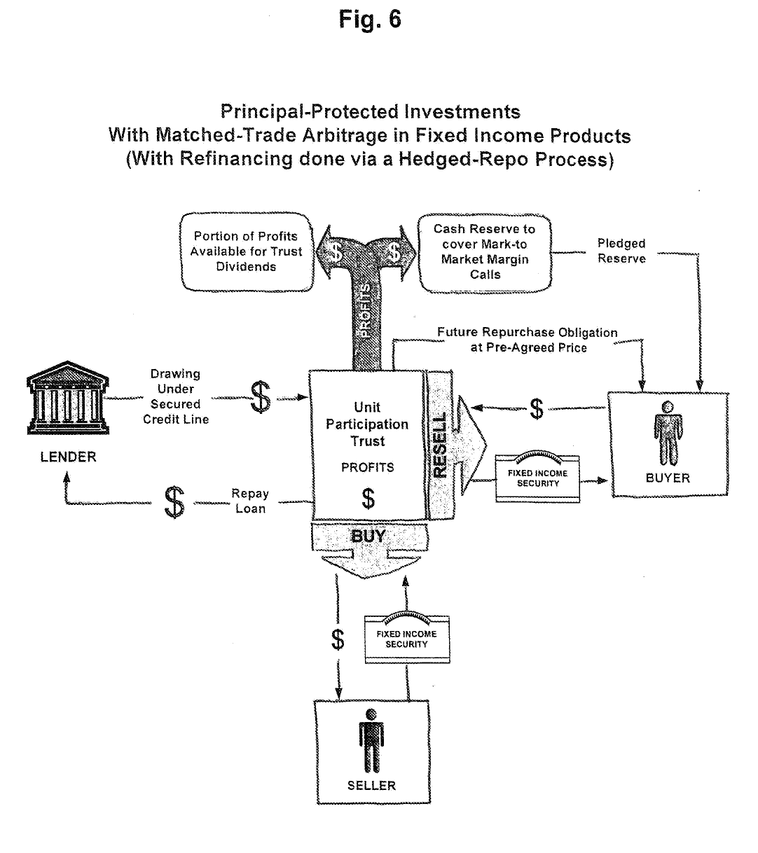

FIG. 6 illustrates an embodiment of a process in which a principal-protected investment is accomplished via matched-trade arbitrage in fixed income products. This embodiment uses cash obtained from a secured loan to invest into permitted investments of the trust. The example depicted in FIG. 6 assumes that refinancing is done via a repo sale of the instrument to a repo buyer rather than a more common matched-trade which is non-recourse to the trust. Profits achieved on a particular trade (e.g., the difference between cost of a security and the income received from its outright sale with a future repurchase obligation) may be allocated to two distinct cash pools that serve different purposes: (a) to fund a mark-to-market reserve set aside and the cost of a non-recourse hedge which is then pledged as collateral to a repo buyer to satisfy any event a drop in value of the security requires satisfaction of a mark-to-market margin call; and (b) to provide dividends to trust unit holders. Again, these are merely examples and claimed subject matter is not limited in scope in this respect.

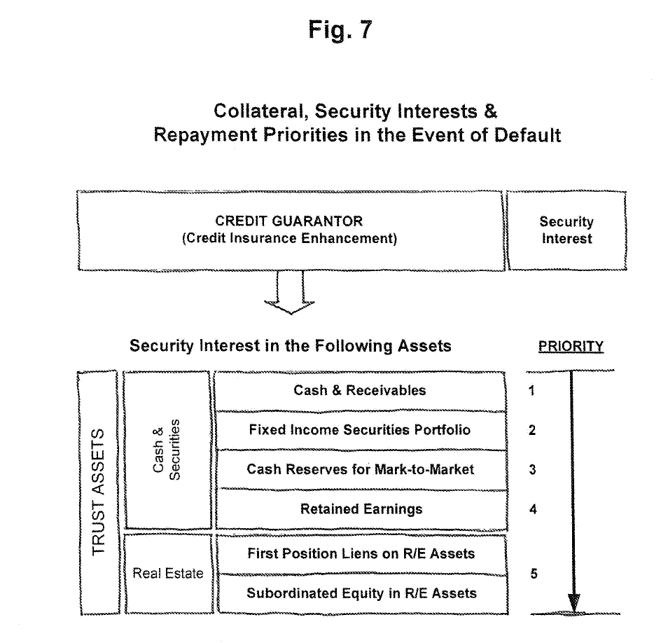

FIG. 7 illustrates an embodiment in which priorities are provided with respect to liquidation of assets of the trust in the event of a default. For example, a lender may liquidate assets of the trust to satisfy the debt obligation of the trust. In this event and for this embodiment, it is anticipated that the investment capital of the trust is depleted through risky investment strategies and all permitted investments of the trust are principal-protected. Based upon these two priorities for this particular embodiment, debt will at all times be satisfied because the principal will not be spent or lost according to investment rules and the profitability of a trade will be sufficient to cover, at least, the interest payment obligation for the intra-day use of funds.

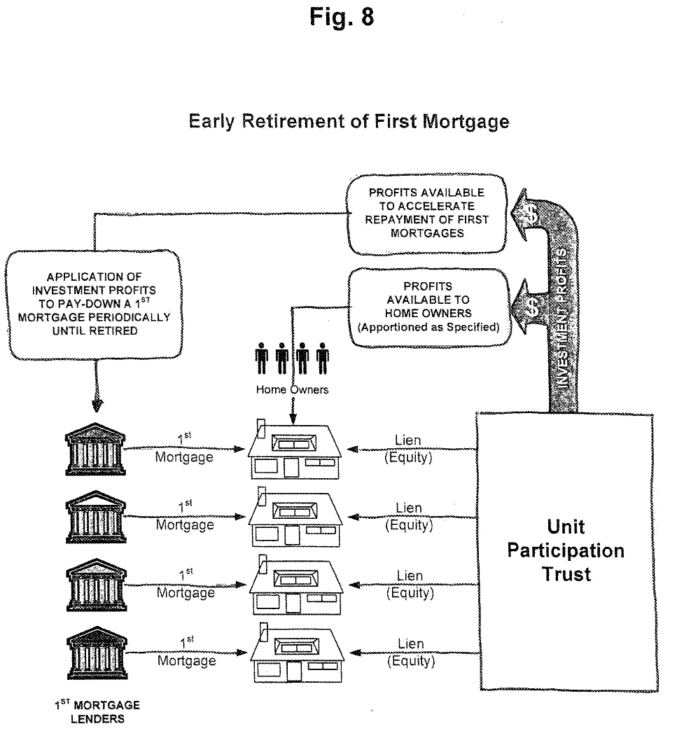

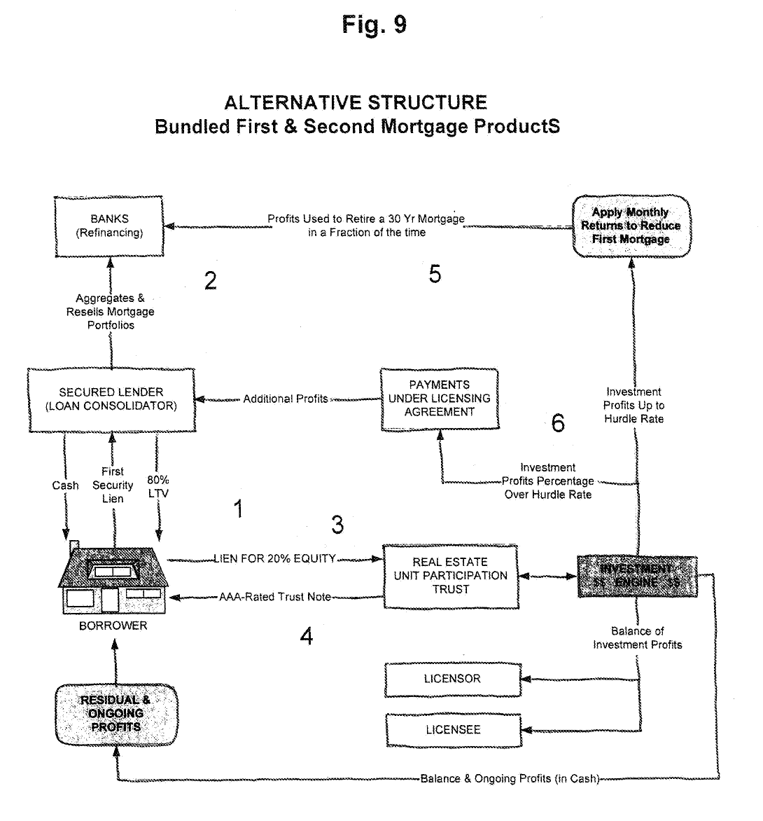

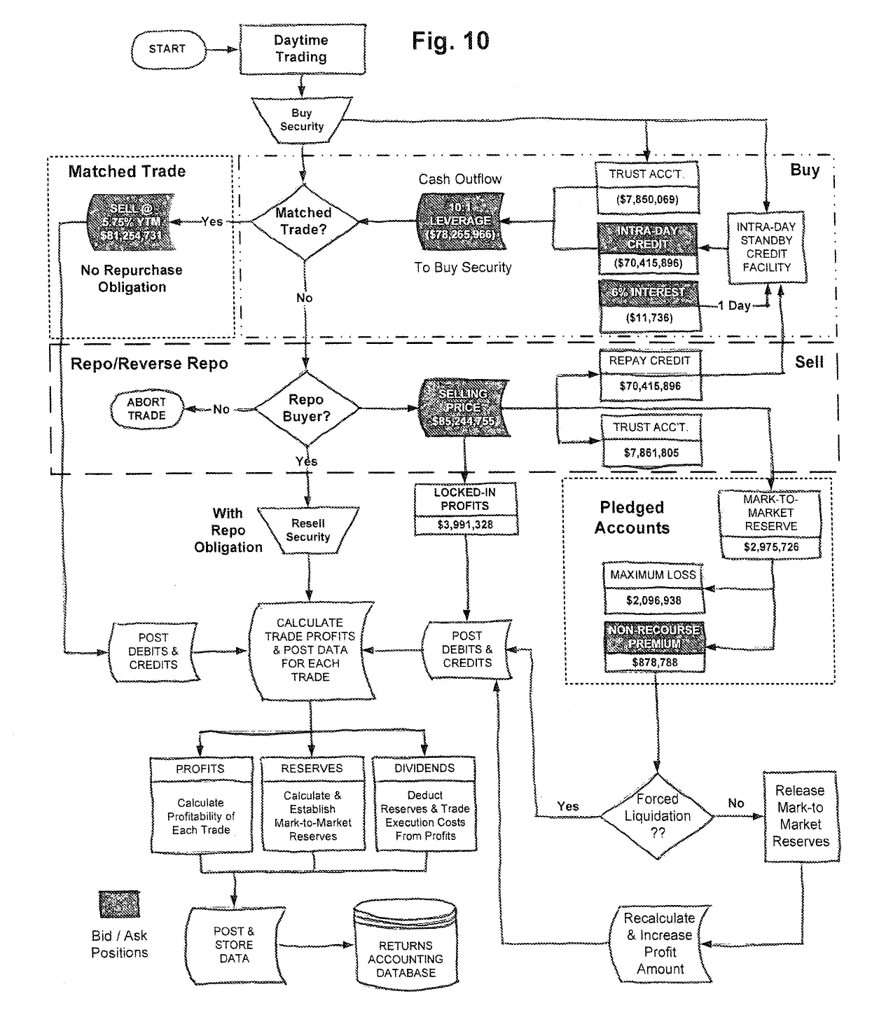

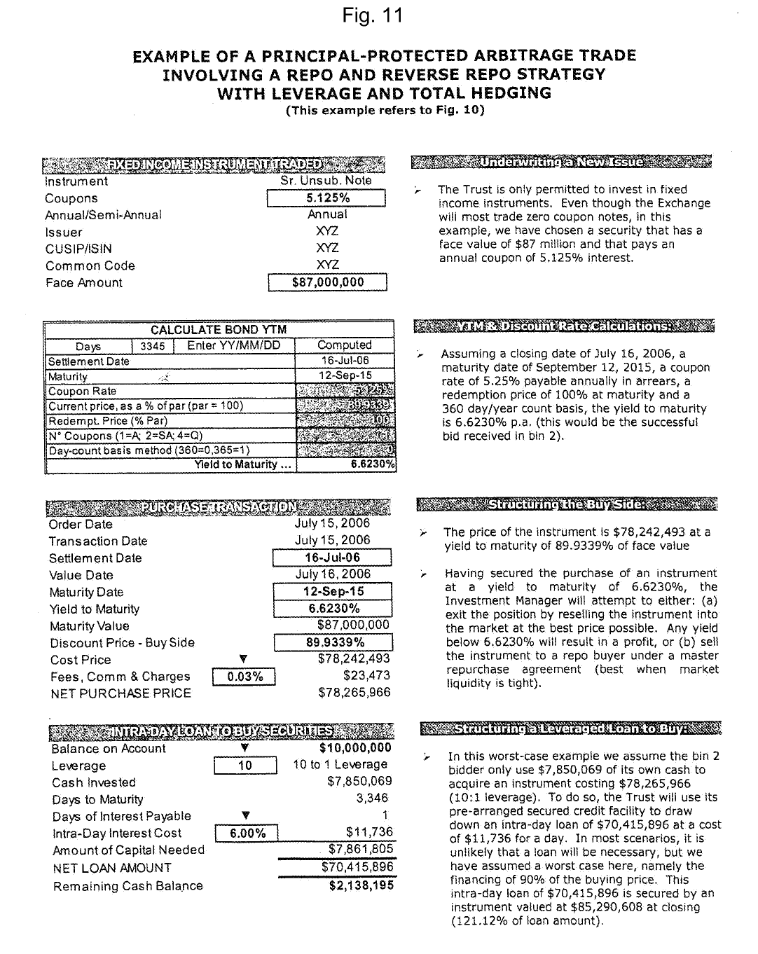

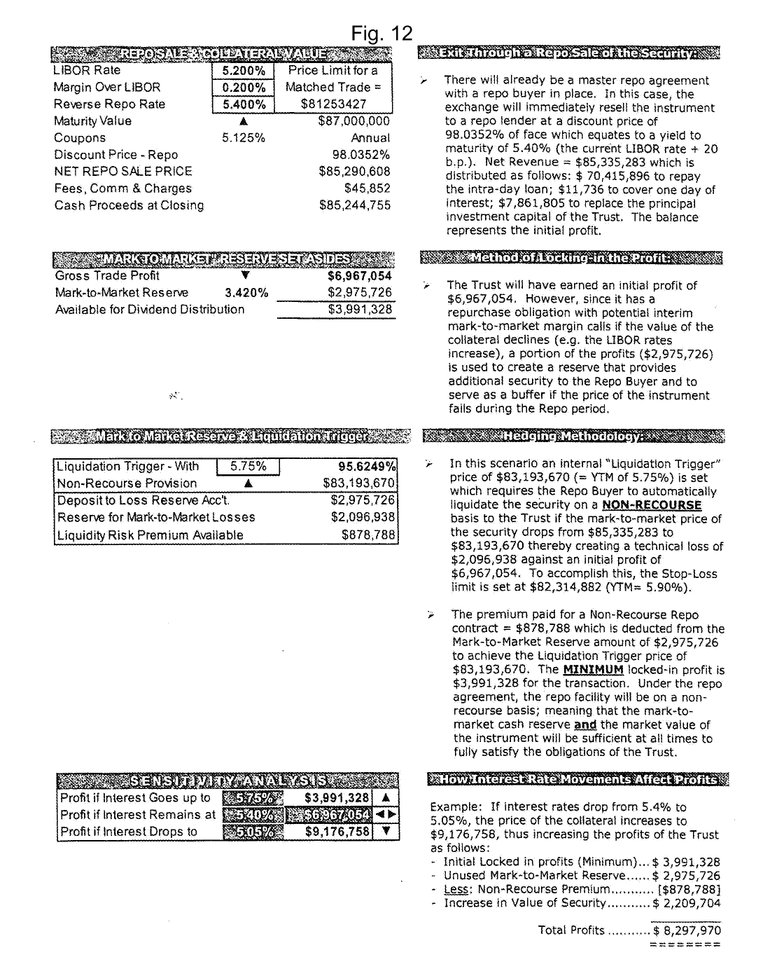

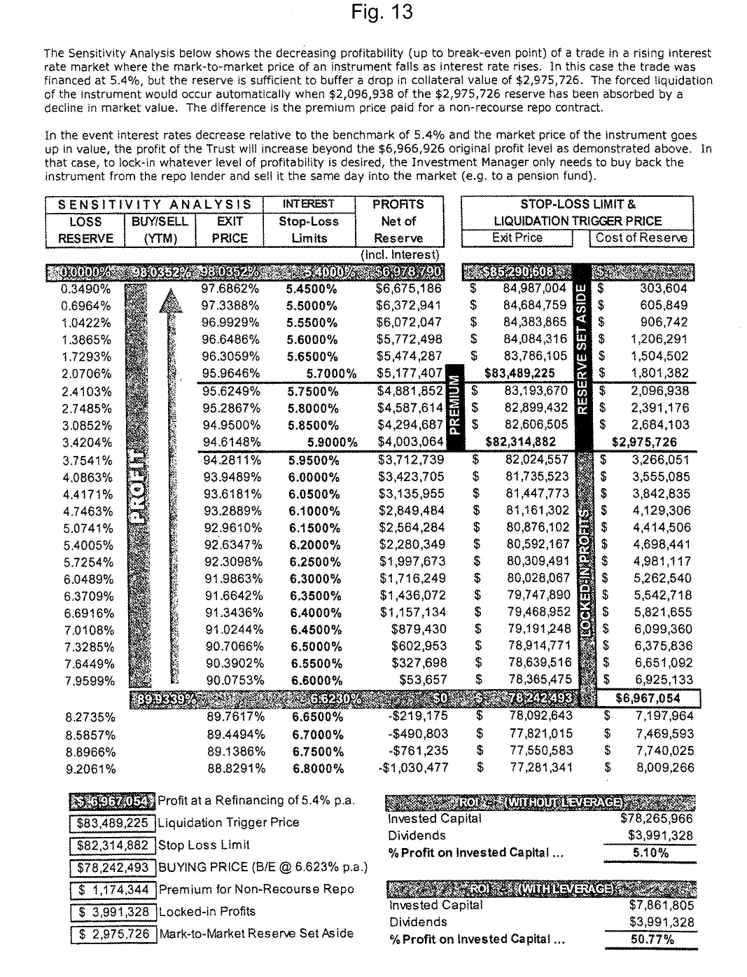

FIG. 8 illustrates an embodiment of a process by which trust dividends are used to retire a unit holders' first mortgages early. Here, trust dividends may be used to retire unit holders' first mortgages early. In this example process, trust dividends (investment profits) may be applied periodically to reduce the principal balance on a mortgage so as to accelerate repayment of the loan resulting in a substantial savings in future interest. The diagram also illustrates the option that the trust unit holder may direct how trust dividends are applied (e.g. 50% to accelerate the retirement of a first mortgage and 50% to provide an immediate taxable income to the unit holder).

### Incorporating Appropriate Language in the Trust Agreement to Allow the Trust to Perform Designated Function

Referring back to the Unit Participation Trust of FIG. 1, this embodiment includes a constructing operation that may make it possible for the trust to operate as an independent stand-alone trust, or as a master trust that includes plural dependent sub-trusts. Constructing may involve, for some embodiments, having the trust agreement define a parent-subsidiary relationship between a parent statutory trust (a master trust) and its at least one dependent statutory trust (sub-trust(s)). Likewise, this embodiment may include having an initial grantor and trustee form that relationship if the trust is formed, and having a separate trust agreement for corresponding master trusts and sub-trusts. Constructing in a particular embodiment may also involve a trust agreement that include at least one dependent sub-trust.

Various types of trusts or trust-like entities are usable in various embodiments in accordance with claimed subject matter. Without limitation, such types include a master trust and at least one dependent sub-trust, with the master trust providing for different classes of unit holders wherein a unit class may, for example, be further constructed to share in overall investment profits of the trust as desired by the trust sponsor, grantor or promoter for payment by the trust to the sponsor, grantor, promoter, unit holders of primary sub-accounts and nested-sub accounts.

Continuing with further details about the trust agreement for a particular embodiment, constructing may involves making the trust agreement allow for the trust to appoint an institutional custodian to provide custody services and plural independent third-party service providers, also referred to as agents to provide services to the trust. Typical agents mau include (e.g. asset managers, registrar, issuing agent, transfer agent, paying agent, exchange rate agent, calculation agent, facility agent, investment rule validation agent, etc.).

For a particular embodiment, construction may also involve a trust agreement that allows the trust to operate as a statutory unit participation trust authorized to issue trust certificates or trust preferred notes to unit holders as evidence of their fractional beneficial ownership interest in the aggregate trust corpus, e.g., the total assets of the trust.

Constructing may also involve making the trust agreement provide for a tax treatment that allows the trust to operate as an organization such as a grantor trust or a partnership. Profits from investments may be taxable as partnership units, rather than as an association taxable as a corporation; and notes may be treated as undivided beneficial ownership interests in the assets of the organization rather than as debt obligations of the organization.

Constructing may also involve seamlessly aggregating available funds of sub-trust accounts and nested sub-accounts at periodic intervals and investing those funds in permitted investments for the benefit of unit/account holders. The aggregated funds may be structured to flow bi-directionally between a sub-trust and its parent master trust to constitute an indebtedness of one trust to another which is registered through debits and credits posted to the corresponding ledgers of various trusts.

Constructing may also involve a fiduciary-based funds-flow structure that allows funds to move upstream from dependent sub-trusts to a corresponding master trust, and allows funds and investment profits to flow downward from the master trust back to the sub-trusts. The funds-flow structure may be based on a contractual agreement between trusts that exists according to pre-defined terms that permit assets and liabilities to be booked and discharged periodically via debit and credit entries in a trust's accounting ledgers, or, optionally may take the legal form of a secured note, an unsubordinated debenture, wherein transferred assets constitute the collateral.

### Establishing a System of Issuing and Redeeming Fractional Units of Ownership in the Trust

Embodiments in accordance with claimed subject matter may also include establishing units of fractional ownership interest equal to a specified unit of currency, and making the credit account balance of a beneficial owner in that currency equal to the total number of units the holder owns at any point in time. For such an embodiment, establishing may involve a trust having at least one unit holder.

For purposes of apportioning and paying trust dividends, for such an embodiment, establishing may involve establishing fractional ownership interest of a unit holder by dividing the number of units held by the total number of units issued by the trust and outstanding at any point in time, and multiplying that percentage by the total distributable dividends.

A unit holder for an example embodiment may comprise a trust, a sub-trust of a unit-issuing entity, an individual, an affiliated group of individuals, a foundation. For such an embodiment, establishing may involve configuring a unit holder's account to post debits and credits in a pre-determined default currency.

With respect to a unit holder's account, for such an embodiment, establishing may involve constructing an account to have plural nested sub-accounts that may be established in a group that includes at least one of any currency other than the default currency, any multi-currency-based index; any commodity-based index and any mixed-currency/commodity-based index. For such an embodiment, establishing may also involve constructing a unit holder's account to post debits and credits for a nested sub-account and to show the balances for currencies and index at the master account level and on periodic account statements. In addition, For such an embodiment, establishing may also involve assigning a unit holder a uniquely-numbered trust sub-account with at least one nested sub-account that may be thought of as a dependent account (e.g. for family members, traveling employees of the same company, etc.). For such an embodiment, establishing may involve constructing a unit holder's account to nest plural cash and non-cash accounts that belong to different unit holders so that an account sponsorship program may be established wherein a unit holder may perform the services of a sponsor/group manager for desired dependent accounts.

For such an embodiment, establishing may also involve several other functions or operations, including utilizing a sponsor/group manager to sponsor at least one dependent account, and distributing trust dividends attributable to subordinate account holders in pre-agreed proportions between the group manager and the subordinate account holders. For such an embodiment, establishing may also involve constructing a trust sub-account to nest plural non-cash account balances belonging to the same account holder. A nested account may also be designed to register debits and credits for non-cash assets deposited into the account (e.g. real estate value deposits, deposits of stocks and bonds) in exchange for a trust note.

Among other functions or operations, establishing may also involve constructing an ownership-interest account management system to segregate assets into two uniquely identified groups of nested accounts: one for cash balances, and one for non-cash assets. This may involve constructing an ownership-interest-determining mechanism to allow individual account holders to join a desired networked group so that individual accounts of group members may be aggregated and pooled for investment purposes. An ownership-interest-managing system may also be constructed to facilitate the aggregation of balances of illiquid asset accounts into a like-kind master illiquid equity account.

A unit holder may be permitted to redeem or put his units to the trust at any time up to the total account balance, and allowing such redeeming, or exercise of a put option, to be made in desired numbers of units or fractions of units and as frequently as desired, whereupon the trust sub-account may register a debit. This ma include allowing a unit holder the option to purchase new trust units at any time and in any amount by causing a deposit of cash to be made to the holder's trust sub-account whereupon the trust sub-account will register a credit.

To accommodate transfer of trust units, this may also including constructing trust units, to be assignable, transferable, and divisible, and to be pledged as security in lending arrangement between the unit holder and a third-party lender. However, again, these are merely examples and claimed subject matter is not limited in scope of these illustrative examples.

### Creating Trust Sub-Accounts to Receive Cash and Non-Cash Deposits.

Trust sub-accounts may in some embodiments be created to receive cash and non-cash deposits. A sub-account may also be created to be able to have plural nested sub-accounts associated with it, to hold deposits in various asset categories, including the following:
(a) cash in the account's default local currency,
(b) cash in any number of foreign currencies wherein a pre-established and authorized amount has been converted into a foreign currency upon instructions of the unit holder,
(c) units of a specified index acquired for cash, wherein the index consists of a portfolio of referenced asset classes in pre-determined proportional percentages and the index derivates its value from a mathematical equation that uses the published referenced values of each target underlying currency, commodity, stock, bond, government security, bank instrument, or other third-party index to periodically determine the index value. The following are provided as examples only of how an index may be constructed: 40% Euros, 20% US Dollars, 20% Australian Dollars, 20% Yen], 50% gold, 30% Euros; 20% US Dollars, 100% gold, 70% gold; 30% platinum, 40% gold, 60% US Government treasuries, 50% Microsoft stock, 30% Google stock, 20% Apple stock, 50% one-year USD certificates of deposit issued by multiple pre-determined major US banks, 50% one year Euro time deposit certificates issued by multiple pre-determined major European banks, 100% the S&P Index;
(d) non-cash assets belonging to the trust unit holder, including, but not limited to, any of the following asset classes: gold bullion deposit certificates, bank instruments; debt instruments; option contracts; commodity contracts, derivative instruments, commodities, equity held in real estate properties, operating and non-operating mining assets, mineral reserve deposits, guaranteed investment contracts, intellectual property patents, investment grade art, valuable jewelry; precious stones; trade receivables, freely traded public company stocks, restricted stocks of public companies, bonds, notes, life insurance policies, portfolios of life settlement policies, transportation equipment; marine craft; contracts of any form between credit-worthy counterparties that provide for a pre-determined future cash flow to the unit holder that can be converted to a present value for appraisal purposes, any other asset that can be appraised and certified by an independent appraiser and where a lien or other form of security interest can be satisfied.

### Opening and Maintaining a Master Custody Account for the Trust.

An embodiment may also include opening and maintaining a master custody account which reflects trust assets that include cash deposited in the custody account, and may also include any other form of tangible asset (e.g. gold bullions, portfolios of stocks and bonds, liens on real estate properties, etc.) and intangible assets (e.g. assignments of appraised patents or other forms of intellectual property). For a particular embodiment, opening and maintaining may include aggregating and maintaining assets of the trust on deposit in a custodial institution pursuant to the execution of a custody agreement between the trust and the custodian. The assets of a master trust in the account of each trust may also be utilized and the balance in the account may be calculated as equal to the total number of trust units issued and outstanding at any point in time less the cost of operating the trust and providing agent services, plus any investment profits earned by the trust from investment activities.

Trust unit accounting functions (e.g. debits and credits to trust sub-account) in one such embodiment may be handled internally by the trust either directly or through a service agent. A trust sub-account may also be configured to accommodate plural nested sub-accounts with a trust-account balance reflecting a first amount of funds and being constructed to subsequently record debits and credits related to the balance, and being accessible via electronic communication.

Likewise, for some embodiments, an account management system may be programmed to operate plural trust sub-accounts and nested sub-accounts and to post transaction-based debits and credits to each. The balance in a sub-account may be accessible at all times by a unit holder with the balance reflecting credit for a first amount of funds, and constructing the sub-account to subsequently record debits and credits related to the balance, and with the account being accessible via remote communication. A master account management system in some embodiments may also reflect the aggregated balance of all sub-accounts for management purposes.

In addition, a custodial account and its dependent accounts may allow available balances to be swept out for overnight investments and swept back and posted in the account at the opening of the next banking day. The cash on deposit in the custody account of the master trust may be segregated into the following four groups, for example: (a) a rainy-day reserve for unforeseen events or circumstances; (b) a daily liquidity reserve, expressed as a percentage of total cash on hand and adjusted periodically to reflect actual experience, sufficient to cover the total estimated daily debit card transaction settlements for all unit holders in a particular day; (c) a percentage of total cash on hand which may be adjusted periodically to reflect actual experience, which may be invested in longer-term investments; and (d) the balance of cash on hand which may be invested in intra-day permitted investments.

An electronic communication structure may also be employed in some embodiments for allowing communication between a master bank account, a custody account and a securities/brokerage account and related sub-accounts and nested accounts.

### Issuing Trust Units to New Depositors in Exchange for Cash and Non-Cash Assets Contributed to the Trust.

Issuing trust units for some embodiments includes issuing desired numbers of new units of a trust to be purchased by purchasers, such as any individual or entity, at any time and to settle the purchase payment using a payment vehicle chosen from the group consisting of cash and a non-cash asset at its pre-determined market or appraised value. This may allow new depositors of cash or non-cash assets to receive newly issued trust units as valuable consideration for the exchange.

Upon the redemption of units resulting from a voluntary action of a unit holder, or the exercise of a put option by the unit holder, for a particular embodiment, redemption of non-cash assets may be satisfied by the trust in one of the following three ways, for example: (a) return (with removal of liens or security interest, if necessary) of the original asset contributed to the trust, free, clear, and unencumbered, whether or not such asset has appreciated or depreciated while on deposit in the trust, (b) transfer of the asset if it is in a transferable form, (c) sale of the asset at the then current market value, as authorized by the unit holder, and return of the liquidation amount as valuable consideration. Of course, these, again, are simply examples.

Cash contributions may be permitted to include the following designated use, purpose and source: deposits held in escrow for a closing, deposits held in attorney IOLTA (Interest on Attorney-Client Trust Accounts), deposits in a sinking fund created to make periodic debt service on a loan, any loan proceeds wherein the proceeds need to be disbursed in stages based on pre-established performance benchmarks, unit subscriptions for an investment fund, savings deposits, endowment funds, trust funds, swept funds for overnight investments, probate funds, health savings account deposits, and deposits to guarantee bids in an auction.

Likewise, non-cash contributions (e.g. deposits) may in some embodiments include any of the following assets: gold bullion deposits, bank instruments; debt instruments; valuable commodities, equity held in real estate properties, mining assets, mineral reserve deposits, guaranteed investment contracts, intellectual property patents, investment grade art, valuable jewelry; precious stones; receivables, freely tradable public company stocks, restricted stocks of public companies, bonds, notes, life insurance policies, portfolios of life settlement policies, transportation equipment; marine crafts; contracts of any form between credit-worthy parties that provide for a certain pre-determined future cash flow to the beneficiary, and any asset which can be appraised by an independent appraiser.

Such an embodiment may, for example, handle fractional ownership of trust assets (e.g. the trust corpus) by being evidenced through issuance and delivery of a trust instrument made to the order of the trust sub-account holder. That instrument could be a trust note, a trust certificate, a dividend-participating trust preferred note paying a variable dividend rate, or a dividend-participating trust preferred note paying a fixed minimum interest (e.g. so-called floor). Thus, in such an embodiment, a note may be delivered to new depositors that may become a trust beneficiary by virtue of the deposit made to depositor's account. The note may be in a paperless form including ledger entries that show a credit to the unit holder's account and a debit to the cash custody account of the trust.

### Adopting Permitted Investment Rules for the Aggregated Liquidity Pool of the Trust.

Likewise, as alluded to previously, the above permitted investment rules, A trust charter may be employed in which investment orders are to be processed and submitted by a designated asset manager and executed by the trustee subsequent to validate that the proposed trade at least meets pre-selected, the permitted investment rules of the trust agreement. Validating, may, for example, be done by a third-party rules validation agent or a trustee-resident electronic rules software which confirms preset validation criteria. This may involve instructing asset managers primarily to invest trust assets in fixed income securities (e.g. debt instruments).

A pre-defined, minimum acceptable credit-rating of a counter-party (e.g. A+ or better by Standard & Poor's, Moody's Financial Services or FitchRatings) may in some embodiments be obtained. Permitted investment strategies may also be used in some embodiments that are in one of the following three categories: (a) “Principal-Protected, Matched Trade” where cash is employed to acquire a security which is immediately resold at a higher price so that the original liquidity, plus an immediate profit, returns to the custody account of the trust; (b) “Available-for-Sale” (held principally for the purpose of reselling in a near term) trades in which a security is acquired and held in the trust's portfolio until a ready, willing and able exit buyer is found and in which liquidity can be obtained in case of need through repo/reverse strategies; (c) “Hold-to-Maturity” (held in the portfolio and available for dealer-directed securities lending purposes and/or repo/reverse repo strategies) trades in which the portfolio can be refinanced for liquidity purposes or sold at any time. However, these are merely a few examples that are intended to be non-limiting.

In some embodiments a security may be acquired that is a newly issued fixed income product (e.g. debt instrument) pursuant to a newly issued underwriting contract. For example, the underwriting contract may be leveraged, meaning that the buyer has entered into a contractual obligation to buy a pre-determined value of securities (measured as the total face value of all securities drawn down during the life of the contract) to be drawn-down at periodic intervals over a pre-determined period of time, and in which the total value of the obligation to buy exceeds the amount of immediately available cash. The underwriting contract may also constructed to provide multiple drawn downs of securities over a pre-determined period, and may be constructed to establish a pre-determined minimum face value amount which may be purchased at any one time.

An underwriting contract may be employed in some embodiments to establish the following criteria: the type of investment grade fixed income products to be issued by the issuer (e.g. debt securities or structured products); the coupon rate, if any; the maturity date; the currency of issue; the denomination of each tradable security; the total amount of securities to be drawn down over a pre-agreed period of time; the conditions for any minimum or maximum purchase amounts; the agreed underwriting spread reflected in the discounted buying price (of face value); the method of payment; the settlement and delivery terms. The underwriting contract may also be constructed to establish a fixed buying price for a new issue of securities purchased over the life of the contract.

A fixed buying price may be employed in some embodiments that includes a volume-based underwriting discount that is measured as a percentage of the face value of the security purchased which is less than par value (e.g. 100% of face value). The underwriting contract in such an embodiment does not necessarily constitute an enforceable obligation of the buyer to buy, and rather may be based on an option system wherein the buyer may call a particular new security and the seller may be obligated to issue and deliver the instrument based on the terms of the contract. Likewise, a security that is a market-seasoned fixed income product may be employed.

### Obtaining a Secured Loan Facility Secured by Non-Cash Assets Held in Trust.

A method embodiment may also include, for example, obtaining a secured loan facility and may use non-cash assets that are pledged as collateral for a short-term loan which, au be intended to provide leverage. Examples of these types of assets include deeds of real estate properties, gold bullion deposit certificates, bank instruments; debt instruments; option contracts; commodity contracts, derivative instruments, commodities, mining assets, mineral reserve deposits, guaranteed investment contracts, intellectual property patents, investment grade art, valuable jewelry; precious stones; trade receivables, freely tradable public company stocks, restricted stocks of public companies, bonds, notes, life insurance policies, portfolios of life settlement policies, transportation equipment; marine crafts; contracts of any form between credit-worthy counterparties that provide for a pre-determined future cash flow to the beneficiary that can be converted to a present value for appraisal purposes, any other form and type of valuable asset which can be appraised and certified by an independent appraiser and where a lien or other form of security interest can be satisfied.

Embodiments in accordance with claimed subject matter may also include any and all of the following: (i) using a leverage facility that is formed by a contractual obligation between a lender and a borrower; (ii) using a loan that is secured by a deposit in trust of all perfected liens and titles evidencing ownership of the assets by the trust; (iii) having a lender receive a promissory note from the trust and the trust assign all of its rights, title and interest in the assets (e.g. cash and non-cash assets) of the trust to the lender (also referred to as an assignee) as collateral for the loan facility; (iv) employing a borrowing trust to constitute and appoint the assignee as its true, lawful and irrevocable attorney-in-fact to demand, receive and enforce payments and to give receipts, releases, satisfactions for, and to sue for all monies payable to the trust; (v) employing a loan to include an intra-day trading facility that is to be repaid at the end of a day; (vi) having the proceeds of a loan be deposited into a master custodial account of the trust and be available for permitted investments.

Likewise, in some embodiments, the proceeds of a loan may be invested in trades that have been pre-approved as a permitted investments of the trust. For some embodiments, pre-approval may be intended to occur by a rules validation agent, or trustee resident investment rules software, for the purpose of ensuring that a contemplated trade conforms to the terms and conditions of the trust.

Embodiments may also: (i) have a loan-to-value-advance rate to be determined by the type of the asset class offered as security; (ii) have the total of cash and securities on deposit in the custody accounts at all times be at least equal to a corresponding loan amount; (iii) have an anticipated profitability of a trade include funds to cover the cost of loan interest for one day; (iv) have a trust to use internally generated liquidity and retained earnings to prepay or guarantee the interest payments for a long-term loan; (v) have a loan to be credit-enhanced by a fee-based loan guarantee (e.g. an financial guarantee insurance product) issued to the benefit of the lender wherein the guarantor is the first line of recourse in the event a default on the debt service; and (vi) have like-kind, non-cash asset classes of a sub-trust to be aggregated at the master custodial account level for the purpose of establishing of a single short-term secured credit facility.

### Distribution of Trust Dividends to Unit Holders.

A method embodiment also may include having aggregated investment profits and interest earned by the master trust or its dependent sub-trusts flow downstream: to the sub-trust's consolidated custodial account, to the primary sub-account of each unit holder, and to a nested sub-account based on the number of units owned by an account holder at a particular point in time relative to the total trust units outstanding at that same point in time.

Primary sub-account holders of a trust may in some embodiments share in the aggregate investment profits attributable to the trust, and be distributable, as well as being distributable to dependent nested sub-accounts, at any point in time and constructing a revenue-sharing mechanism to pay a preset percentage. That percentage may be established by the trust sponsor, promoter or grantor, or left to the discretion of a holder of the primary sub-account.

Embodiments may also include: (i) a dividend distribution percentage different for different trusts and modifiable over time (e.g. by agreement that may also change over time); (ii) different classes of trust units that have different dividend-sharing benefits and percentages being allocated to holders of primary sub-accounts and nested sub-accounts; and (iii) sponsors, grantors, and promoters of a trust being able to hold different classes of beneficial ownership units that have different revenue-sharing benefits and percentages than those of holders of primary sub-accounts and nested sub-accounts.

### Another Aspect of the Invention—Forming an Investment Engine.

In addition to a method of forming a standardized trust structure, another aspect of the invention is a method/system of forming an investment engine for use within by a standardized trust structure. That method includes the step of constructing and implementing a principal-protected investment mechanism.

### Implementing a Principal-Protected Investment Mechanism.

The constructing and implementing step involves an implementation mechanism that is designed to minimize [or eliminate] investment risk for the master trust and its dependent sub-trusts while maximizing investment returns through the execution of proprietary, rule-based, investment strategies.

Utilization of the constructing and implementing step/function results in an implementation mechanism that has many facets, including that it: (i) establishes a definition of proprietary investment rules that govern all permitted investments of the trust; (ii) incorporates the proprietary investment rules for permitted Investments in the trust agreement; (iii) appoints a permitted-investment-rules agent to provide an independent trade order validation service to the trustee; (iv) provides to the rules agent a rule-based controller capable of controlling all investment functions according to the proprietary, pre-selected permitted investment rules; (v) provides the trustee with the same rule-based controller to optionally provide a redundant rules validation process; (vi) constrains the liquidity outflows and inflows for each trade to a single currency to avoid currency fluctuation risks; and (vii) adopts the same governing trust agreement for the master trust and its dependent sub-trusts.

The implementation mechanism also converts and incorporates the proprietary investment rules for trust funds into a preferably software-implemented, rule-based controller or rule-validation controller. The controller, which may also be thought of as an engine, is operable on a resident server and accessible to approved investment managers worldwide via an internet or intranet connection to a suitable server. The controller functions by automatically: (a) receiving investment orders electronically from investment managers via an intranet connection to the server; (b) analyzing each submission to ensure all the details of a particular trade are submitted, including settlement terms and conditions; (c) validating the source, authority and limits ascribed a particular investment manager under an asset management agreement and a technology license agreement; (d) breaking down the details of the order into verifiable components; (e) comparing each component of the trade against the permitted investment rules of the trust, accessing in the process both internal and external information databases to validate each component; (f) authorizing the execution of the trade order by providing the trustee with a unique order-specific validation code if all components of the trade comply with the permitted investment rules of the trust, or rejects the order by returning it to the originating asset manager indicating the reasons for noncompliance; (g) optionally, at the sole option of the trustee, providing a reprocessing of the previous three steps above at the trustee level so as to revalidate the order, thereby adding a second unique trustee-originated revalidation code to the order.

The constructing and implementing step/function also makes an implementation mechanism that operates a selection subsystem for electing and appointing plural investment professionals globally so that funds are accessible by any or all during their hours of activity for one type of investment strategy, and in another throughout multiple time zones during their night, thereby providing for maximum utilization of the liquidity pool.

The implementation mechanism also: (i) requires all strategic and tactical investment decisions to be made by investment professionals that are licensed to execute proprietary principal-protected investment strategies for the benefit of the trust; (ii) provides an allocation system for allocating pooled trust assets to plural investment managers globally; (iii) defines a method for each investment professional to access trust funds for investment purposes through the rule-based controller; (iv) places all investment execution responsibilities with the trustee in accordance with pre-defined terms and conditions of a legally binding trust agreement; (v) provides errors and omissions insurance coverage for the trustee; (vi) allocates cash funds on deposit in the master trust and its sub-trusts to multiple investment professionals and limits each to a pre-determined maximum amount; (vii) apportions a pre-set cash reserve defined as a percentage of total trust assets (which can be redefined periodically based on actual experience) for periodic settlement of all debit transactions by trust unit holders; (viii) and aggregates available daily cash balances of all trust sub-accounts and nested accounts into the trust's custody account and causes those balances to be invested in (daytime and overnight) permitted investments.

In addition to those features described above, the constructing and implementing step/function also makes an implementation mechanism that: (i) combines all aggregated trust balances into a single liquidity pool available through the master trust; (ii) provides a proprietary daytime rule-based investment strategy and an overnight strategy for maximum effectiveness of the investment platform and investment funds; (ii) operates a bid system for pre-approved, credit-worthy, securities brokerage firms, banks and financial institutions to obtain overnight or short-term liquidity from the trust to allow them to enhance their balance sheets, settle completed intra-day trades of their own, and invest in repo and reverse repo strategies involving third-parties; (iii) processes a daily fund sweep operation to provide funds to successful bidders; (iv) receives and processes funds swept overnight to successful bidders; (v) disaggregates funds at the master trust level and redistributes the original investment amount, plus proportional investment profits, to each class of unit holders that is prescribed in the trust agreement; (vi) disaggregates funds at the trust level and redistributes the original investment amount, plus proportional investment profits, to each class of unit holders as prescribed in the trust agreement; and (vii) provides a linked debit card to individual trust unit holders to enable them to withdraw cash and investment profits from their account.

### Another Aspect of the Invention—Adopting an Investment Strategy.

In addition to the above methods/systems of forming a standardized trust structure and forming an investment engine, respectively, another aspect of the invention is a method/system of adopting an investment strategy. That strategy complies with permitted investment rules of a trust and simultaneously eliminates risks while increasing return on investment. Plural sub-strategies are followed, including the following: arbitrage trading strategies, overnight sweep strategies, risk mitigation strategies and profit maximization strategies; eliminating trade execution, credit and liquidity risks in arbitrage trading strategies; applying financial leverage to increase profitability; applying refinancing techniques involving repo and reverse repo strategies, collateralization and risk management strategies; and including the plural sub-strategies in the investment strategy.

### Arbitrage Trading Strategies.

The arbitrage trading sub-strategy involves investment of trust funds by identifying and capturing profitable market pricing differentials through a buy-and-immediately-resell process where the differential between the purchase price and the exit resale price results in an immediate profit to the buyer-reseller. That sub-strategy also involves investment of trust funds by: (i) exploiting differentials or inefficiencies in fixed-income securities pricing or pricing inefficiencies in the market between related fixed-income securities; and (ii) hedging of the exposure to interest rate risk.

The arbitrage trading sub-strategy also involves requiring: (i) asset managers to invest trust funds in overnight or longer-term strategies; and (ii) securities held for trading purposes to be reported at their fair market value, with unrealized gains recognized in current earnings.

### Overnight Sweep Strategies.

The overnight sweep sub-strategy involves requiring the aggregated, end-of-day liquidity pool to be swept to plural counter-party financial institutions for overnight investment. This sub-strategy involves requiring: (i) approved financial institutions to meet the credit-rating requirements established as a minimum acceptable threshold (e.g. A+ short-term rating by Standard & Poor's, Moody's Financial Services or FitchRatings); (ii) trust funds to be aggregated and swept at the end of a banking day and returned by the bank's opening time the next banking day; (iii) financial institutions periodically to submit bids for at least part of the aggregated liquidity pool of the trust, and wherein the bids that offer the highest returns prevail for a pre-set period of time; and (iv) institutions that submit successful bids to use trust-originated liquidity obtained from the trust to bolster or periodically re-calibrate their balance sheet ratios as required by pre-set rules (such as the Basle II accord or as mandated by local banking regulators).

The overnight sweep sub-strategy involves institutions that submit successful bids to use trust-originated liquidity to finance their own repo and reverse repo trades and to settle, during the night, transactions within a pre-set time period (such as those that are closed during the day and need to settle during a particular night).

The overnight sweep sub-strategy also involves requiring: (i) counterparties to pay a pre-defined fee (measured in basis points multiplied by the swept amount) to use trust funds each time they use the aggregated liquidity of the trust [to finance or settle one of] for their own completed trades; and (ii) a sweeping-of-funds process that is constructed to enable funds to be swept to financial institutions globally from location to location for the purpose of maximizing revenue by exploiting time zones differentials globally (e.g. while it is still night-time in San Francisco, it is daytime consecutively in Hong Kong and subsequently in London, efficiently providing a potential multiplication of income for the same trust liquidity pool).

### Trading Velocity and Profit Maximization Strategies.

The trading velocity and profit maximization sub-strategies involve the frequent buying and selling (trading velocity) of fixed income securities for the purpose of generating profits either on short-term fluctuations in price, the arbitrage of market pricing inefficiencies, or the arbitrage of pricing differentials that exist by virtue of volume discounts that apply to the underwriting of new issues of fixed income products.

The trading velocity and profit maximization sub-strategies also involve maximizing trading velocity and minimizing execution and implementation risks through a “matched-trade” process involving two contracts, a supply contract and a sales contract wherein: (a) the first contract obligates an issuer to issue and sell, or a pre-owned portfolio owner to sell securities based on pre-established terms and conditions; (b) the second to obligate a ready, willing and able exit buyer to buy securities based on substantially similar pre-agreed terms and conditions, save the selling price.

In addition, the trading velocity and profit maximization sub-strategies involve accelerating trading velocity by rapid execution of buy-and-immediately-resell matched-trade orders, which when combined with a guaranteed-profitability for each buy-sell trade tickets submitted for execution, results in an accelerated, profit-producing, investment engine. These sub-strategies also require that accelerating trading velocity continues until the supply contract is exhausted.

### Eliminating Trade Execution and Credit Risks in Arbitrage Trading Strategies.

The eliminating trade execution and credit risks in arbitrage trading sub-strategies (“the eliminating risks sub-strategies”) involve ensuring that conditions for a “principal-protected” (or “riskless-principal”), “matched-trade” exist, namely: (a) a fixed income security is pre-sold before it is purchased; (b) the settlement risk is eliminated through some form of guarantee of payment against delivery, and (c) the exit price is greater than the purchase price (predictable profitability).

These eliminating risks sub-strategies involve eliminating payment risk through: (i) a simultaneous escrow closing process or a face-to-face table-top closing; and (ii) a block-and-pay process wherein an instrument which is screenable and deliverable via a global clearing and settlement platform (e.g. DTC, Euroclear, or Clearstream) is first electronically blocked by the buyer's trading desk to guarantee delivery after the payment side of the transaction is processed. The block occurs by entering a seller-originated blocking code, accessing the screen of the instrument via the global clearing and settlement platform and replacing the seller-originated blocking code by a new one so as to prevent further access to the blocked instrument. The eliminating risks sub-strategies also involve eliminating trade execution risks through: (i) the process of matching the trade tickets on the buy side and the sell side before executing a trade; and (ii) the process of ensuring that each match trade is profitable and will not result in a depleted liquidity pool.

### Financial Leverage Strategies.

The financial leverage sub-strategies involve leveraging a purchased fixed income security through the use of an intra-day line of credit or margin loan to finance the purchase of a security (e.g. in a 5-times leverage, the buyer uses $20 of his own money and borrows $80 as a margin loan to buy a security priced at $100; in a 10-times leverage, the buyer uses $10 of his own money and borrows $90 to buy a security priced at $100).

The financial leverage sub-strategies also involve: (i) securing leverage by a pledge of the security, until resold; (ii) constructing leverage to increase the earning power of available funds and the profitability of a particular trade; and (iii) constructing a trade only to permit use of leverage if the trade is: (a) predictably profitable, and (b) a matched-trade condition exists (the use of borrowed funds is but for a brief moment and the liquidity is almost immediately recovered, and the loan repaid).

In addition, the financial leverage sub-strategies also involve constructing a trade to use the leverage process to increase profitability of a trade relative to the original invested amount. For example, a borrower uses $20 and borrows $80 to buy a security costing $100, and then immediately resells it at $100.50 and pays back the loan and one day of interest [$80+$0.03]. This leaves the purchaser with the original liquidity, plus a profit of $0.47 on an initial cash investment of $20, which relative to the initial investment is 2.35% for an intra-day trade. Had the $100 purchase been executed without leverage, the profit would have only been 0.5%. The greater the leverage, the higher the profit percentage is relative to the initial cash outlay.

The financial leverage sub-strategies involve subjecting the application of leverage to a standby credit facility agreement that establishes, minimally, the maximum leverage permitted for the purchase of a particular security, the automatic pledge of the security as collateral, the definition of what constitutes eligible collateral, and the use of the loan proceeds to settle the purchase of eligible securities.

### Liquidity Strategies Involving Repo and Reverse Repo Sales.

The liquidity sub-strategies involve selling a newly acquired security under the terms and conditions of a master repurchase agreement (a repo sale) for the purpose of replenishing liquidity after a permitted security has been acquired for cash. The repo seller is contractually obligated to repurchase the security at the original selling price, plus accrued interest up to the day of the repurchase based on a variable interest rate determined periodically by an inter-bank rate (e.g. LIBOR or EURIBOR), and the repo seller is obligated to make periodic interest payments to the repo buyer for the use of his funds. A repo sale is equivalent to a secured loan, except that in the case of a repo sale title to the security transfers to the buyer at the onset and the seller is obligated to buy back the instrument at some future date.

The liquidity sub-strategies involve structuring the repo as an open repo wherein there is no fixed repurchase deadline and the repo can occur at any time up to maturity date of the collateral so long as the repo seller continues to pay periodic interest payments.

The liquidity sub-strategies also involve: (i) ensuring that the expected liquidity from the repo sale is greater than the cost of the instrument (so-called excess liquidity); and (ii) combining the repo sale with a subsequent interest rate swap involving the sale of a contract that delivers periodic variable interest rates in exchange for a fixed interest rate one. This strategy definitively and permanently locks-in the profitability of a trade at the cost of abandoning the upside profitability in the event interest rates decline.

The liquidity sub-strategies also involve ensuring excess liquidity is sufficient to pre-fund all of the following reserves and trade execution costs while still providing excess liquidity distributable as pure profit on the trade: (i) the establishment of a cash reserve designed to protect the repo buyer against a loss of value of the collateral in the event interest rates increase and there is a mark-to-market margin call, (ii) the establishment of a stoploss cash reserve wherein the maximum acceptable loss for a particular trade, up to the pre-defined stop-loss limit, secures fully the risk associated with a depreciation of the collateral in the event of an adverse interest rate movement, (iii) the establishment of a hedge that guarantees a non-recourse liquidation of the collateral instrument in a rising interest rate market, wherein consideration paid for the hedge premium guarantees that the stop-loss limit will not be exceeded regardless of market liquidity conditions at the time the liquidation event occurs.

The liquidity sub-strategies also involve automatically liquidated collateral by selling it into the market at the point in time when the mark-to-market reserve equals the amount obtained by adding the current market price of the instrument, the total up-to-date amounts of all mark-to-market margin calls, plus the premium charged by the hedge guarantor for the establishment of a non-recourse liquidity guarantee in the event of a liquidation caused by an adverse interest movement resulting in a drop in the value of the collateral.

The liquidity sub-strategies may also involve: (i) pledging the mark-to-market cash reserve to the repo buyer in any form or manner and is fully available to the repo buyer to satisfy any and all mark-to-market collateral margin calls if required; and (ii) requiring the hedge guarantor (the repo buyer or a third-party guarantor) to assume any and all liquidity risk in the event the automatic liquidation trigger point established by the stop-loss limit is reached, thus fully depleting the mark-to-market reserve set aside.

The liquidity sub-strategies also involve requiring the guarantor, as consideration for the premium paid for the hedge, to take on any and all liquidity risks in the event of a forced liquidation and such liquidation is on a non-recourse basis to the repo seller.

In addition, the liquidity sub-strategies involve limiting the maximum exposure to the repo seller to the loss of the entire pre-funded mark-to-market reserve set aside, including the cost of the hedge premium.

The liquidity sub-strategies require, in the event of a forced liquidation, that the hedge guarantor acquires the instrument for his own account at a price equal to the stop-loss limit less the premium paid for the establishment of the hedge and immediately reselling it into the market at break-even, or a profit or a loss.

The liquidity sub-strategies require, in the event of a forced liquidation, that the hedge guarantor causes the repo buyer to liquidate the instrument at the then current market price and pays for any liquidity shortfall if a loss is incurred.

The liquidity sub-strategies involve in the event the hedge guarantor is also the repo buyer, the repo buyer liquidates the instrument and absorbs any profit or loss on the transaction.

The liquidity sub-strategies allow, in the event of a declining interest rate market, resulting in an increase in the market value of the collateral, under the terms of an “open repo” agreement, that the original seller may at any time repurchase the collateral from the repo buyer at the original price plus accrued interest, and liquidate the security in the market at a profit.

The liquidity sub-strategies allow the repurchase to liberate the lien placed on the mark-to-market reserve and the reserved amount less the cost of the hedge premium is returned to the repo seller, thereby substantially increasing the profitability of the trade for the repo seller.

The liquidity sub-strategies also require that the total profit on the trade equals the profit achieved by: (i) repurchasing the collateral security from the repo buyer and (ii) immediately reselling it into the market at a profit, plus the excess liquidity (which can be booked as a distributable profit) obtained at the time of the original repo refinancing transaction

### Collateralization & Risk Management Strategies.

The collateralization and risk management sub-strategies involve minimizing the risk of default in a margin loan agreement through a process of financial engineering involving: (a) an exit strategy that guarantees the rapid intra-day execution of a profitable matched trade so that there is no liquidity drain but an increase in liquidity instead, (b) a settlement process of delivery versus payment (DVP) where the settlement risk is also eliminated; and (c) a simultaneous closing of the buy and resell portions of the transaction.

The collateralization and risk management sub-strategies require that, in the unlikely event of a default, the lender's recourse is, first, against the cash and receivables; second, against the securities held in the portfolio; third, against any mark-to-market reserve set asides that may exist; fourth, against retained earnings.

The collateralization and risk management sub-strategies also involve minimizing risk through a trade execution strategy that gives all trade implementation responsibilities to a fiduciary trustee, in which the fiduciary trustee adopts strict investment rules that do not permit the initial investment capital to be depleted.

The collateralization and risk management sub-strategies also require that at all times, the balance of cash, plus the securities portfolio (valued at the current mark-to-market price), plus the cash reserves pledged to cover the risk of mark-to-market margin calls, must be equal to or greater than the cumulative exposure to the lender.

### Trading Strategies & Risk Management.

The trading strategies and risk management sub-strategies involve addressing liquidity, credit, interest rate, hedging, and settlement risks issues through the adoption of “permitted investment” rules that exist for the purpose of protecting the initial investment principal while guaranteeing a profitable outcome for a trade. These sub-strategies involve utilizing: (i) a riskless-principal, matched trade strategy to complete a simultaneous buy-sell trade consisting of the purchase of a security followed by its immediate resale at a profit to a third-party buyer, wherein the sale is final and is on a non-recourse basis to the seller (i.e., a permitted investment strategy); and (ii) a matching a trade to the purchase of a security combined with repo sale to a repo buyer (a so-called matched repo exit), wherein the liquidity obtained from the repo sale is greater than the original cash outlay (again, a permitted investment strategy).

The collateralization and risk management sub-strategies also involve using a financial leverage to increase the profitability of a trade if it is accompanied by a hedging strategy that eliminates the downside risk in a profitable matched-trade (a permitted investment strategy).

The collateralization and risk management sub-strategies involve utilizing a gains trading strategy for the purpose of enabling the purchase of a security and the subsequent sale of that security at a profit after a short holding period (a permitted investment strategy).

The collateralization and risk management sub-strategies also involve: (i) combining a gains trading strategy with a short-term repo sale of the instrument to a repo buyer; (ii) accounting the interest carry cost of the refinancing as an increased cost of the security; (iii) permitting repo sale of securities as an exit refinancing strategy designed to replenish liquidity after a permitted security has been acquired with cash (a permitted investment strategy).

The collateralization and risk management sub-strategies also involve allowing when-issued-securities-trading strategies to facilitate the buying and selling of securities in the period between the announcement of an offering/underwriting and the issuance and payment date of the securities (a permitted investment strategy).

The collateralization and risk management sub-strategies also involve employing securities-lending strategies to produce additional fee-based income that increases the aggregated yield-to-maturity of a security portfolio, wherein in return for lending its securities, the lender receives a fee, which is quoted as basis points per annum of the original market value of loaned securities (a permitted investment strategy).

In addition, these sub-strategies involve utilizing a pairing-off strategy to enable the buyer to commit to purchase a security and to subsequently pair-off the purchase with a sale of the same security wherein one party to the transaction remits the difference between the purchase and sale price to the counterparty (a permitted investment strategy). The pairing-off strategy also involves the same sequence of events when using interest rate swaps, options on swaps, forward commitments, options on forward commitments, and other derivative contracts (a permitted investment strategy). The collateralization and risk management sub-strategies may also involve utilizing a hedging-with-derivatives strategy to eliminate risks associated with uncertain events (e.g. whether interest rates will rise or fall over the life of a contract) (a permitted investment strategy).

The collateralization and risk management sub-strategies also involve requiring that a hedge consists of swapping a variable interest rate contract (one type of derivative) for a fixed rate one (another type of derivative) to lock-in a fixed interest rate over the expected life of a contract. The swap is replaced by a swap option (so-called swaptions) that does not immediately lock-in the fixed rate but gives the option holder the right to lock-in the rate at a future date, if desired.

The collateralization and risk management sub-strategies involve utilizing an offsetting-and-netting strategy to net out the present or future payment or delivery obligations or entitlements arising under or in connection with one or more financial contracts entered into by the parties to a master-netting agreement. The collateralization and risk management sub-strategies involve the offsetting and netting process involves two amounts due under two or more master netting agreements.

The offsetting and netting process involves: (i) the determination of any payment or delivery obligations or entitlements under one or more financial contracts entered into under a netting agreement; (ii) the acceleration of any payment or delivery obligations or entitlements under one or more financial contracts entered into under a netting agreement; and (iii) the calculation of one of the following: a close-out value, a market value, a liquidation value; a replacement value in respect of a terminated or accelerated obligation.

The collateralization and risk management sub-strategies involve addressing risk mitigation through the adoption of investment rules and guidelines that exclude certain investment strategies that are deemed to be of a speculative nature and therefore do not fully protect the initial investment principal.

The collateralization and risk management sub-strategies also involve prohibiting certain types of trading activity such as requiring that: (i) short selling a security for the purpose of speculating that its price will fall over time is not permitted; and (ii) convergence trading that involves a bet that the price difference between two assets will narrow (or converge) in the future is not permitted. Short selling is the sale of a security that is not owned. In a short sale a security is borrowed from a dealer and sold into the market and is later returned to the dealer through a repurchase on the market after the price has fallen below the sale price (a prohibited strategy). A convergence trade generally involves buying (so-called going long on) the cheaper asset and selling (going short on) the more expensive asset and reversing the trades when the prices of the two assets become more similar (a prohibited strategy).

### Another Way to Characterize the Invention.

Please refer to Attachment A.

### Another Way to Characterize the Invention.

The invention may also be characterized by the following numbered paragraphs:

1. A method of forming a standardized trust structure, comprising: forming a trust by an agreement, with the trust including an aggregated liquidity pool; constructing the trust agreement to allow the trust to perform preselected functions; establishing a system of issuing and redeeming fractional units of ownership in the trust; creating trust sub-accounts to receive cash and non-cash deposits; opening and maintaining a master custody account for the trust; issuing trust units to new depositors in exchange for cash and non-cash assets contributed to the trust; adopting permitted investment rules for the aggregated liquidity pool of the trust; obtaining a secured loan facility secured by non-cash assets held in the trust; and distributing trust dividends to unit holders.

2. The method of paragraph 1, wherein the forming step involves determining if the trust is to be a stand alone trust, a master trust or a sub-trust of a master trust.

3. The method of paragraph 1, wherein the forming step involves appointing a fiduciary trustee to act as trustee of the trust.

4. The method of paragraph 1, wherein the forming step involves licensing plural grantors to form their own sub-trusts of a master trust.

5. The method of paragraph 1, wherein the forming step involves the forming a unit participation trust by executing a trust agreement between the trustee and plural grantors who each make a contribution to the initial trust corpus to form the trust.

6. The method of paragraph 1, wherein the forming step involves appointing an institutional custodian to provide trust custody services.

7. The method of paragraph 1, wherein the forming step involves appointing plural independent third-party service providers to provide services to the trust.

8. The method of paragraph 1, further including the step of incorporating the trust with government authorities and receiving in return a certificate of trust.

9. The method of paragraph 1, wherein the forming step involves forming a structured finance architecture with a bankruptcy-remote special purpose company designed to accommodate plural stockholders; a trust indenture; a trustee; a custodian; wherein the special purpose company issues callable notes or debentures which may be called at any time and in any fractional amount, and where the option to call is revolving so as to give birth to a new call option each time a call is made by withdrawing cash from the stockholder's account; and wherein the architecture provides a revenue-producing debit card to end users.

10. The method of paragraph 1, wherein the forming step involves forming a structure chosen from the group consisting of a mutual fund, a mutual banking institution, a unit participation fund and any form of a unit trust.

11. The method of paragraph 1, wherein the constructing step involves making it possible for the trust either to operate as an independent stand-alone trust, or as a master trust that includes plural dependent sub-trusts.

12. The method of paragraph 11, wherein the constructing step involves making the trust agreement define a parent-subsidiary relationship between a parent statutory trust and its at least one dependent statutory trust and requiring that an initial grantor and trustee form that relationship when the trust is formed, and making a separate trust agreement for each master trust and sub-trust.

13. The method of paragraph 11, wherein the constructing step involves making the trust agreement include at least one dependent sub-trust.

14. The method of paragraph 11, wherein the constructing step involves making the trust agreement, chosen from the group consisting of a master trust and at least one dependent sub-trust, provide for different classes of unit holders wherein each unit class can be further constructed to share in overall investment profits of the trust as desired by the trust sponsor, grantor or promoter for payment by the trust to the sponsor, grantor, promoter, unit holders of primary sub-accounts and nested-sub accounts.

15. The method of paragraph 11, wherein the constructing step involves making the trust agreement allow for the trust to appoint an institutional custodian to provide custody services and plural independent third-party service providers to provide services to the trust.

16. The method of paragraph 11, wherein the constructing step involves making the trust agreement allow the trust to operate as a statutory unit participation trust authorized to issue trust certificates or trust preferred notes to unit holders as evidence of their fractional beneficial ownership interest in the aggregate trust corpus.

17. The method of paragraph 16, wherein the constructing step involves making the trust agreement provide for a tax treatment that allows the trust to operate as an organization chosen from the group consisting of a grantor trust and a partnership, wherein profits are taxable as partnership units; and notes are treated as undivided beneficial ownership interests in the assets of the organization rather than as debt obligations of the organization.

18. The method of paragraph 11, wherein constructing step involves seamlessly aggregating available funds of sub-trust accounts and nested sub-accounts at periodic intervals and investing those funds in permitted investments for the benefit of unit/account holders.

19. The method of paragraph 11, wherein the constructing step involves aggregating funds to flow bidirectionally between a sub-trust and its parent master trust to constitute an indebtedness of one trust to another which is registered through debits and credits posted to the corresponding ledgers of each trust.

20. The method of paragraph 11, wherein the constructing step involves making a fiduciary-based funds-flow structure that allows funds to move upstream from dependent sub-trusts to a corresponding master trust, and allows funds and investment profits to flow downward from the master trust back to the sub-trusts, with the funds-flow structure being based on a contractual agreement between trusts that exists according to pre-defined terms in the trust agreement permitting assets and liabilities to be booked and discharged periodically via debit and credit entries in each trust's accounting ledgers, or, optionally may take the legal form of a secured note, an unsubordinated debenture, wherein transferred assets constitute the collateral.

21. The method of paragraph 1, wherein the establishing step involves making each unit of fractional ownership interest equal to a specified unit of currency and making the credit account balance of a beneficial owner in that currency equal to the total number of units the holder owns at any point in time.

22. The method of paragraph 21, wherein the establishing step involves making each trust have at least one unit holders.

23. The method of paragraph 21, wherein the establishing step involves, for purposes of apportioning and paying trust dividends, establishing the fractional ownership interest of a unit holder by dividing the number of units held by the total number of units issued by the trust and outstanding at any point in time, and multiplying that percentage by the total distributable dividends.

24. The method of paragraph 21, wherein the establishing step involves a unit holder that is chosen from the group consisting of a trust, a sub-trust of a unit-issuing entity, an individual, an affiliated group of individuals, a foundation, a non-profit organization, an institution, a fund, a corporation, and a governmental entity.

25. The method of paragraph 21, wherein the establishing step involves configuring each unit holder's account to post debits and credits in a pre-determined default currency.

26. The method of paragraph 21, wherein the establishing step involves constructing each unit holder's account to have plural nested sub-accounts that may be established in a group that includes at least one of any currency other than the default currency, any multi-currency-based index; any commodity-based index and any mixed-currency/commodity-based index.

27. The method of paragraph 21, wherein the establishing step involves constructing each unit holder's account to post debits and credits for each nested sub-account and to show the balances for each currency and index at the master account level and on periodic account statements.

28. The method of paragraph 21, wherein the establishing step involves assigning each unit holder a uniquely-numbered trust sub-account with at least one nested sub-account.

29. The method of paragraph 21, wherein the establishing step involves constructing each unit holder's account to nest plural cash and non-cash accounts that belong to different unit holders so that the an account sponsorship program can be established wherein a unit holder may perform the services of a sponsor/group manager for desired dependent accounts.

30. The method of paragraph 21, wherein the establishing step involves utilizing a sponsor/group manager to sponsor at least one dependent account.

31. The method of paragraph 21, wherein the establishing step involves distributing trust dividends attributable to subordinate account holders in pre-agreed proportions between the group manager and the subordinate account holders.

32. The method of paragraph 21, wherein the establishing step involves constructing each trust sub-account to nest plural non-cash account balances belonging to the same account holder.

33. The method of paragraph 21, wherein the establishing step involves designing each nested account to register debits and credits for non-cash assets deposited into the account in exchange for a trust note.

34. The method of paragraph 21, wherein the establishing step involves constructing an ownership-interest account management system to segregate assets into two uniquely identified groups of nested accounts: one for cash balances, and one for non-cash assets;

35. The method of paragraph 21, wherein the establishing step involves constructing an ownership-interest-determining mechanism to allow individual account holders to join a desired networked group so that individual accounts of group members can be aggregated and pooled for investment purposes.

36. The method of paragraph 21, wherein the establishing step involves constructing an ownership-interest-managing system to facilitate the aggregation of the balances of all illiquid asset accounts into a single like-kind master illiquid equity account.

37. The method of paragraph 21, wherein the establishing step involves allowing a unit holder to redeem or put his units to the trust at any time up to the total account balance, and allowing such redeeming to be made in desired numbers of units or fractions of units and as frequently as desired, whereupon the trust sub-account will register a debit.

38. The method of paragraph 21, wherein the establishing step involves allowing a unit holder the option to purchase new trust units at any time and in any amount by causing a deposit of cash to be made to the holder's trust sub-account whereupon the trust sub-account will register a credit.

39. The method of paragraph 21, wherein the establishing step involves constructing trust units, to be assignable, transferable, and divisible, and to be pledged as security in lending arrangement between the unit holder and a third-party lender.

40. The method of paragraph 1, wherein the creating step involves configuring plural sub-trust accounts and plural nested sub-accounts to hold deposits in asset categories chosen from the group consisting of: (a) cash in the account's default local currency; (b) cash in any number of foreign currencies wherein a pre-established and authorized amount has been converted into a foreign currency upon instructions of the unit holder; (c) units of a specified index acquired for cash, wherein the index consists of a portfolio of referenced asset classes in pre-determined proportional percentages and the index derivates its value from a mathematical equation that uses the published referenced values of each target underlying currency, commodity, stock, bond, government security, bank instrument, or other third-party index to periodically determine the index value; (d) non-cash assets belonging to the trust unit holder, including, but not limited to, any of the following asset classes: gold bullion deposit certificates, bank instruments; debt instruments; option contracts; commodity contracts, derivative instruments, commodities, equity held in real estate properties, operating and non-operating mining assets, mineral reserve deposits, guaranteed investment contracts, intellectual property patents, investment grade art, valuable jewelry; precious stones; trade receivables, freely traded public company stocks, restricted stocks of public companies, bonds, notes, life insurance policies, portfolios of life settlement policies, transportation equipment; marine craft; contracts of any form between credit-worthy counterparties that provide for a pre-determined future cash flow to the unit holder that can be converted to a present value for appraisal purposes, any other asset that can be appraised and certified by an independent appraiser and where a lien or other form of security interest can be satisfied.

41. The method of paragraph 1, wherein the opening and maintaining step involves trust assets that include cash deposited in the custody account, and also include any other form of tangible asset and intangible assets.

42. The method of paragraph 41, wherein the opening and maintaining step involves aggregating and maintaining the assets of the trust on deposit in a custodial institution pursuant to the execution of a custody agreement between the trust and the custodian.

43. The method of paragraph 41, wherein the opening and maintaining step involves utilizing the assets of a master trust in the account of each trust and calculating the balance in the account as equal to the total number of trust units issued and outstanding at any point in time less the cost of operating the trust and providing agent services, plus any investment profits earned by the trust from investment activities.

44. The method of paragraph 41, wherein the opening and maintaining step involves handling all trust unit accounting functions internally by the trust either directly or through a service agent.

45. The method of paragraph 41, wherein the opening and maintaining step involves configuring each trust sub-account to accommodate plural nested sub-accounts, each having a trust-account balance reflecting a first amount of funds and being constructed to subsequently record debits and credits related to the balance, and being accessible via electronic communication.

46. The method of paragraph 41, wherein the opening and maintaining step involves programming an account management system to operate plural trust sub-accounts and nested sub-accounts and to post transaction-based debits and credits to each.

47. The method of paragraph 41, wherein the opening and maintaining step involves making the balance in each sub-account accessible at all times by a unit holder and making the balance reflect credit for a first amount of funds, and constructing the sub-account to subsequently record debits and credits related to the balance, and to be accessible via remote communication.

48. The method of paragraph 41, wherein the opening and maintaining step involves enabling a master account management system to reflect the aggregated balance of all sub-accounts for management purposes.

49. The method of paragraph 41, wherein the opening and maintaining step involves configuring each custodial account and its dependent accounts to allow available balances to be swept out for overnight investments and swept back and posted in the account at the opening of the next banking day.

50. The method of paragraph 41, wherein the opening and maintaining step involves segregating the cash on deposit in the custody account of the master trust into the following four groups: (a) a rainy-day reserve for unforeseen events or circumstances; (b) a daily liquidity reserve, expressed as a percentage of total cash on hand and adjusted periodically to reflect actual experience, sufficient to cover the total estimated daily debit card transaction settlements for all unit holders in a particular day; (c) a percentage of total cash on hand which may be adjusted periodically to reflect actual experience, which may be invested in longer-term investments; and (d) the balance of cash on hand which may be invested in intra-day permitted investments only.

51. The method of paragraph 41, wherein the opening and maintaining step involves including an electronic communication structure for allowing communication between a master bank account, a custody account and a securities/brokerage account and all related sub-accounts and nested accounts.

52. The method of paragraph 1, wherein the issuing step involves allowing desired numbers of new units of a trust to be purchased by purchasers at any time and to settle the purchase payment using a payment vehicle chosen from the group consisting of cash and a non-cash asset at its pre-determined market or appraised value.

53. The method of paragraph 52, wherein the issuing step involves allowing new depositors of cash or non-cash assets to receive newly issued trust units.

54. The method of paragraph 53, wherein the issuing step involves allowing redemption of non-cash assets to be satisfied by the trust in one of the following three ways: (a) the return of the original asset contributed to the trust, unencumbered, whether or not such asset has appreciated or depreciated while on deposit in the trust, (b) the transfer of the asset if it is in a transferable form, (c) a sale of the asset at the then current market value, as authorized by the unit holder, and the return of the liquidation amount as valuable consideration;

55. The method of paragraph 53, wherein the issuing step involves allowing cash contributions to include the following designated use, purpose and source: deposits held in escrow for a closing, deposits held in attorney IOLTA, deposits in a sinking fund created to make periodic debt service on a loan, any loan proceeds wherein the proceeds need to be disbursed in stages based on pre-established performance benchmarks, unit subscriptions for an investment fund, savings deposits, endowment funds, trust funds, swept funds for overnight investments, probate funds, health savings account deposits, and deposits needed to guarantee bids in an auction.

56. The method of paragraph 53, wherein the issuing step involves allowing non-cash contributions to include any of the following assets: gold bullion deposits, bank instruments; debt instruments; valuable commodities, equity held in real estate properties, mining assets, mineral reserve deposits, guaranteed investment contracts, intellectual property patents, investment grade art, valuable jewelry; precious stones; receivables, freely tradable public company stocks, restricted stocks of public companies, bonds, notes, life insurance policies, portfolios of life settlement policies, transportation equipment; marine crafts; contracts of any form between credit-worthy parties that provide for a certain pre-determined future cash flow to the beneficiary, and any asset which can be appraised by an independent appraiser.

57. The method of paragraph 52, wherein the issuing step involves having fractional ownership of trust assets being evidenced through the issuance and delivery of a trust instrument made to the order of the trust sub-account holder and belonging to a group consisting of: a trust note, a trust certificate, a dividend-participating trust preferred note paying a variable dividend rate, and a dividend-participating trust preferred note paying a fixed minimum interest.

58. The method of paragraph 57, wherein the issuing step involves allowing a note to be delivered to each new depositor that becomes a trust beneficiary by virtue of the deposit made to depositor's account.

59. The method of paragraph 57, wherein the issuing step involves allowing a note to be in a paperless form including ledger entries that show a credit to the unit holder's account and a debit to the cash custody account of the trust.

60. The method of paragraph 1, wherein the adopting step involves marking a trust charter that requires all investment orders be processed and submitted by a designated asset manager and executed by the trustee subsequent to validating that the proposed trade at least meets preselected, the permitted investment rules of the trust agreement.

61. The method of paragraph 60, wherein the adopting step involves instructing asset managers primarily to invest trust assets in fixed income securities.

62. The method of paragraph 61, wherein the adopting step involves requiring a pre-defined, minimum acceptable credit-rating of a counter-party.

63. The method of paragraph 62, wherein the adopting step involves using permitted investment strategies that are in one of the following three categories: (a) “Principal-Protected, Matched Trade” where cash is employed to acquire a security which is immediately resold at a higher price so that the original liquidity, plus an immediate profit, returns to the custody account of the trust; (b) “Available-for-Sale” trades in which a security is acquired and held in the trust's portfolio until a ready, willing and able exit buyer is found and in which liquidity can be obtained in case of need through repo/reverse strategies; (c) “Hold-to-Maturity” trades in which the portfolio can be refinanced for liquidity purposes or sold at any time.

64. The method of paragraph 63, wherein the adopting step involves using acquired security that is a newly issued fixed income product pursuant to a newly issued underwriting contract.

65. The method of paragraph 64, wherein the adopting step involves using an underwriting contract that is leveraged, meaning that the buyer has entered into a contractual obligation to buy a pre-determined value of securities to be drawn-down at periodic intervals over a pre-determined period of time, and in which the total value of the obligation to buy exceeds the amount of immediately available cash.

66. The method of paragraph 65, wherein the adopting step involves using an underwriting contract that is constructed to provide multiple drawn downs of securities over a pre-determined period.

67. The method of paragraph 66, wherein the adopting step involves using an underwriting contract that is constructed to establish a pre-determined minimum face value amount which may be purchased at any one time.

68. The method of paragraph 67, wherein the adopting step involves using an underwriting contract that is constructed to establish the following criteria: the type of investment grade fixed income products to be issued by the issuer; the coupon rate, if any; the maturity date; the currency of issue; the denomination of each tradable security; the total amount of securities to be drawn down over a pre-agreed period of time; the conditions for any minimum or maximum purchase amounts; the agreed underwriting spread reflected in the discounted buying price; the method of payment; the settlement and delivery terms.

69. The method of paragraph 65, wherein the adopting step involves using an underwriting contract that is constructed to establish a fixed buying price for each new issue of securities purchased over the life of the contract.

70. The method of paragraph 69, wherein the adopting step involves using a fixed buying price that includes a volume-based underwriting discount that is measured as a percentage of the face value of the security purchased which is less than par value.

71. The method of paragraph 65, wherein the adopting step involves using an underwriting contract does not constitute an enforceable obligation of the buyer to buy, and rather is based on an option system wherein the buyer may call a particular new security and the seller is obligated to issue and deliver the instrument based on the terms of the contract.

72. The method of paragraph 63, wherein the adopting step involves using a security that is a market-seasoned fixed income product.

73. The method of paragraph 1, wherein the obtaining step involves using non-cash assets that are pledged as collateral for a short-term loan which is intended to provide leverage.

74. The method of paragraph 73, wherein the adopting step involves using a leverage facility that is formed by a contractual obligation between a lender and a borrower.

75. The method of paragraph 73, wherein the adopting step involves using a loan that is secured by a deposit in trust of all perfected liens and titles evidencing ownership of the assets by the trust.

76. The method of paragraph 73, wherein the adopting step involves requiring a lender to receive a promissory note from the trust and the trust to assign all of its rights in the assets of the trust to the lender as collateral for the loan facility.

77. The method of paragraph 76, wherein the adopting step involves requiring a borrowing trust to appoint the assignee as its irrevocable attorney-in-fact to demand, receive and enforce payments and to give receipts, releases, satisfactions for, and to sue for all monies payable to the trust.

78. The method of paragraph 73, wherein the adopting step involves requiring a loan to consist of an intra-day trading facility that must be repaid at the end of each day.

79. The method of paragraph 73, wherein the adopting step involves requiring that all of the proceeds of a loan be deposited into a master custodial account of the trust and only be available for permitted investments.

80. The method of paragraph 73, wherein the adopting step involves requiring that the proceeds of a loan may only be invested in trades that have been pre-approved as a permitted investments of the trust.

81. The method of paragraph 73, wherein the adopting step involves requiring a loan-to-value-advance rate to be determined by the type of the asset class offered as security.

82. The method of paragraph 73, wherein the adopting step involves requiring that the total of cash and securities on deposit in the custody accounts must at all times be at least equal to a corresponding loan amount.

83. The method of paragraph 73, wherein the adopting step involves requiring that an anticipated profitability of a trade must include funds to cover the cost of loan interest for one day.

84. The method of paragraph 83, wherein the adopting step involves requiring a trust to use internally generated liquidity and retained earnings to prepay or guarantee the interest payments for a long-term loan.

85. The method of paragraph 73, wherein the adopting step involves requiring a loan to be credit-enhanced by a fee-based loan guarantee issued to the benefit of the lender wherein the guarantor is the first line of recourse in the event a default on the debt service.

86. The method of paragraph 73, wherein the adopting step involves requiring like-kind, non-cash asset classes of a sub-trust to be aggregated at the master custodial account level for the purpose of establishing of a single short-term secured credit facility.

87. The method of paragraph 1, wherein the distributing step involves requiring aggregated investment profits and interest earned by the master trust or its dependent sub-trusts to flow downstream, first to the sub-trust's consolidated custodial account, then to the primary sub-account of each unit holder, then to each nested sub-account based on the number of units owned by each account holder at a particular point in time relative to the total trust units outstanding at that same point in time.

88. The method of paragraph 87, wherein the distributing step involves allowing primary sub-accounts holders of a trust to share in the aggregate investment profits attributable to the trust, and distributable to each as well as the dependent nested sub-accounts, at any point in time and constructing a revenue-sharing mechanism to pay a preset percentage.

89. The method of paragraph 87, wherein the distributing step involves allowing the dividend distribution percentage to be different for each trust and modifiable over time.

90. The method of paragraph 87, wherein the distributing step involves allowing holders of primary sub-accounts and nested sub-accounts to be allocated different classes of trust units that have different dividend-sharing benefits and percentages.

91. The method of paragraph 87, wherein the distributing step involves allowing sponsors, grantors, and promoters of a trust to hold a different class of beneficial ownership units that have a different revenue-sharing benefits and percentages than those of holders of primary sub-accounts and nested sub-accounts.

92. A method of forming an investment engine for use within by a standardized trust structure, comprising: constructing and implementing a principal-protected investment mechanism.

93. The method of paragraph 92, wherein the constructing and implementing step involves an implementation mechanism that is designed to minimize investment risk for the master trust and its dependent sub-trusts while maximizing investment returns through the execution of proprietary, rule-based, investment strategies.

94. The method of paragraph 93, wherein the constructing and implementing step involves an implementation mechanism that establishes a [detailed] definition of proprietary investment rules that govern all permitted investments of the trust.

95. The method of paragraph 93, wherein the constructing and implementing step involves an implementation mechanism that incorporates the proprietary investment rules for permitted Investments in the trust agreement.

96. The method of paragraph 93, wherein the constructing and implementing step involves an implementation mechanism that appoints a permitted-investment-rules agent to provide an independent trade order validation service to the trustee.

97. The method of paragraph 93, wherein the constructing and implementing step involves an implementation mechanism that provides to the rules agent a rule-based controller capable of controlling all investment functions according to the proprietary investment rules.

98. The method of paragraph 93, wherein the constructing and implementing step involves an implementation mechanism that provides the trustee with the same rule-based controller to optionally provide a redundant rules validation process.

99. The method of paragraph 93, wherein the constructing and implementing step involves an implementation mechanism that constrains the liquidity outflows and inflows for each trade to a single currency.

100. The method of paragraph 93, wherein the constructing and implementing step involves an implementation mechanism that adopts the same governing trust agreement for the master trust and its dependent sub-trusts.

101. The method of paragraph 93, wherein the constructing and implementing step involves an implementation mechanism that converts and incorporates the proprietary investment rules into a rule-validation controller that accessible to approved investment managers, and wherein the controller automatically: (a) receives investment orders electronically from investment managers via an intranet connection to the server; (b) analyzes each submission to ensure all the details of a particular trade are submitted, including settlement terms and conditions; (c) validates the source, authority and limits ascribed a particular investment manager under an asset management agreement and a technology license agreement; (d) breaks down the details of the order into verifiable components; (e) compares each component of the trade against the permitted investment rules of the trust, accessing in the process both internal and external information databases to validate each component; (f) authorizes the execution of the trade order by providing the trustee with a unique order-specific validation code if all components of the trade comply with the permitted investment rules of the trust, or rejects the order by returning it to the originating asset manager indicating the reasons for noncompliance; (g) optionally, at the sole option of the trustee, providing a reprocessing of the previous three steps above at the trustee level so as to revalidate the order, thereby adding a second unique trustee-originated revalidation code to the order.

102. The method of paragraph 93, wherein the constructing and implementing step involves an implementation mechanism that operates a selection subsystem for electing and appointing plural investment professionals globally so that funds are accessible by any or all during their hours of activity for one type of investment strategy, and in another throughout multiple time zones during their night, thereby providing for maximum utilization of the liquidity pool.

103. The method of paragraph 93, wherein the constructing and implementing step involves an implementation mechanism that requires all strategic and tactical investment decisions to be made by investment professionals that are licensed to execute proprietary principal-protected investment strategies for the benefit of the trust.

104. The method of paragraph 93, wherein the constructing and implementing step involves an implementation mechanism that provides an allocation system for allocating pooled trust assets to plural investment managers.

105. The method of paragraph 93, wherein the constructing and implementing step involves an implementation mechanism that defines a method for each investment professional to access trust funds for investment purposes through the rule-based controller.

106. The method of paragraph 93, wherein the constructing and implementing step involves an implementation mechanism that places all investment execution responsibilities with the trustee in accordance with pre-defined terms of a trust agreement.

107. The method of paragraph 93, wherein the constructing and implementing step involves an implementation mechanism that provides errors and omission insurance coverage for the trustee.

108. The method of paragraph 93, wherein the constructing and implementing step involves an implementation mechanism that allocates cash funds on deposit in the master trust and its sub-trusts to multiple investment professionals and limits each to a pre-determined maximum amount.

109. The method of paragraph 93, wherein the constructing and implementing step involves an implementation mechanism that apportions a pre-set cash reserve defined as a percentage of total trust assets for periodic settlement of all debit transactions by trust unit holders.

110. The method of paragraph 93, wherein the constructing and implementing step involves an implementation mechanism that aggregates available daily cash balances of all trust sub-accounts and nested accounts into the trust's custody account and causes those balances to be invested in permitted investments.

111. The method of paragraph 93, wherein the constructing and implementing step involves an implementation mechanism that combines all aggregated trust balances into a single liquidity pool available through the master trust.

112. The method of paragraph 93, wherein the constructing and implementing step involves an implementation mechanism that provides a proprietary daytime rule-based investment strategy and an overnight strategy for maximum effectiveness of investments.

113. The method of paragraph 93, wherein the constructing and implementing step involves an implementation mechanism that operates a bid system for pre-approved, credit-worthy, securities brokerage firms, banks and financial institutions to obtain overnight or short-term liquidity from the trust to allow them to enhance their balance sheets, settle completed intra-day trades of their own, and invest in repo and reverse repo strategies involving third-parties.

114. The method of paragraph 93, wherein the constructing and implementing step involves an implementation mechanism that processes a daily fund sweep operation to provide funds to successful bidders.

115. The method of paragraph 93, wherein the constructing and implementing step involves an implementation mechanism that receives and processes funds swept overnight to successful bidders.

116. The method of paragraph 93, wherein the constructing and implementing step involves an implementation mechanism that disaggregates funds at the master trust level and redistributes the original investment amount, plus proportional investment profits, to each class of unit holders that is prescribed in the trust agreement.

117. The method of paragraph 93, wherein the constructing and implementing step involves an implementation mechanism that disaggregates funds at the trust level and redistributes the original investment amount, plus proportional investment profits, to each class of unit holders as prescribed in the trust agreement.

118. The method of paragraph 93, wherein the constructing and implementing step involves an implementation mechanism that provides a linked debit card to individual trust unit holders to enable them to withdraw cash and investment profits from their account.

119. A method of adopting an investment strategy that complies with permitted investment rules of a trust and simultaneously eliminates risks while increasing return on investment, comprising: considering plural sub-strategies that include arbitrage trading strategies, overnight sweep strategies, risk mitigation strategies and profit maximization strategies; eliminating trade execution, credit and liquidity risks in arbitrage trading strategies; applying financial leverage to increase profitability; applying refinancing techniques involving repo and reverse repo strategies, collateralization and risk management strategies; and including the plural sub-strategies in the investment strategy.

120. The method of paragraph 119, wherein the arbitrage trading sub-strategy involves investment of trust funds by identifying and capturing profitable market pricing differentials through a buy-and-immediately-resell process where the differential between the purchase price and the exit resale price results in an immediate profit to the buyer-reseller.

121. The method of paragraph 119, wherein the arbitrage trading sub-strategy involves investment of trust funds by exploiting differentials or inefficiencies in fixed-income securities pricing or pricing inefficiencies in the market between related fixed-income securities.

122. The method of paragraph 119, wherein the arbitrage trading sub-strategy involves investment of trust funds by hedging of the exposure to interest rate risk.

123. The method of paragraph 119, wherein the arbitrage trading sub-strategy involves requiring asset managers to invest trust funds in overnight or longer-term strategies.

124. The method of paragraph 119, wherein the arbitrage trading sub-strategy involves requiring that securities held for trading purposes are reported at their fair market value, with unrealized gains recognized in current earnings.

125. The method of paragraph 119, wherein the overnight sweep sub-strategy involves requiring the aggregated end-of-day liquidity pool to be swept to plural counter-party financial institutions for overnight investment.

126. The method of paragraph 119, wherein the overnight sweep sub-strategy involves requiring approved financial institutions to meet the credit-rating requirements established as a minimum acceptable threshold.

127. The method of paragraph 119, wherein the overnight sweep sub-strategy involves requiring trust funds to be aggregated and swept at the end of a banking day and returned by the bank's opening time the next banking day.

128. The method of paragraph 119, wherein the overnight sweep sub-strategy involves requiring financial institutions periodically to submit bids for at least part of the aggregated liquidity pool of the trust, and wherein the bids that offer the highest returns prevail for a pre-set period of time.

129. The method of paragraph 119, wherein the overnight sweep sub-strategy involves requiring institutions that submit successful bids to use trust-originated liquidity obtained from the trust to bolster or periodically re-calibrate their balance sheet ratios as required by pre-set rules.

130. The method of paragraph 119, wherein the overnight sweep sub-strategy involves institutions that submit successful bids to use trust-originated liquidity to finance their own repo and reverse repo trades and to settle transactions within a pre-set time period.

131. The method of paragraph 119, wherein the overnight sweep sub-strategy involves requiring counterparties to pay a pre-defined fee to use trust funds each time they use the aggregated liquidity of the trust for their own completed trades.

132. The method of paragraph 119, wherein the overnight sweep sub-strategy involves requiring a sweeping-of-funds process that is constructed to enable funds to be swept to financial institutions globally for the purpose of maximizing revenue by exploiting time zones differentials globally.

133. The method of paragraph 119, wherein the trading velocity and profit maximization sub-strategies involve the frequent buying and selling (trading velocity) of fixed income securities for the purpose of generating profits either on short-term fluctuations in price, the arbitrage of market pricing inefficiencies, or the arbitrage of pricing differentials that exist by virtue of volume discounts that apply to the underwriting of new issues of fixed income products.

134. The method of paragraph 119, wherein the trading velocity and profit maximization sub-strategies involve maximizing trading velocity and minimizing execution and implementation risks through a “matched-trade” process involving two contracts, a supply contract and a sales contract wherein: (a) the first contract obligates an issuer to issue and sell, or a pre-owned portfolio owner to sell securities based on pre-established terms and conditions; (b) the second to obligate a ready, willing and able exit buyer to buy securities based on substantially similar pre-agreed terms and conditions, save the selling price.

135. The method of paragraph 119, wherein the trading velocity and profit maximization sub-strategies involve accelerating trading velocity by rapid execution of buy-and-immediately-resell matched-trade orders, which when combined with a guaranteed-profitability for each buy-sell trade tickets submitted for execution, results in an accelerated, profit-producing, investment engine.

136. The method of paragraph 119, wherein the trading velocity and profit maximization sub-strategies require that accelerating trading velocity continues until the supply contract is exhausted.

137. The method of paragraph 119, wherein the eliminating trade execution and credit risks in arbitrage trading sub-strategies (“the eliminating risks sub-strategies”) involve ensuring that conditions for a “principal-protected” (or “riskless-principal”), “matched-trade” exist, namely: (a) a fixed income security is pre-sold before it is purchased; (b) the settlement risk is eliminated through some form of guarantee of payment against delivery, and (c) the exit price is greater than the purchase price (predictable profitability).

138. The method of paragraph 119, wherein the eliminating risks sub-strategies involve eliminating payment risk through a simultaneous escrow closing process or a face-to-face table-top closing.

139. The method of paragraph 137, wherein the eliminating risks sub-strategies involve eliminating payment risk through a block-and-pay process wherein an instrument which is screenable and deliverable via a global clearing and settlement platform is first electronically blocked by the buyer's trading desk to guarantee delivery after the payment side of the transaction is processed.

140. The method of paragraph 137, wherein the eliminating risks sub-strategies involve eliminating trade execution risks through the process of matching the trade tickets on the buy side and the sell side before executing a trade.

141. The method of paragraph 137, wherein the eliminating risks sub-strategies involve eliminating trade execution risks through the process of ensuring that each match trade is profitable and will not result in a depleted liquidity pool.

142. The method of paragraph 119, wherein the financial leverage sub-strategies involve leveraging a purchased fixed income security through the use of an intra-day line of credit or margin loan to finance the purchase of a security.

143. The method of paragraph 142, wherein the financial leverage sub-strategies involve securing leverage by a pledge of the security, until resold.

144. The method of paragraph 142, wherein the financial leverage sub-strategies involve constructing leverage to increase the earning power of available funds and the profitability of a particular trade.

145. The method of paragraph 142, wherein the financial leverage sub-strategies involve constructing a trade only to permit use of leverage if the trade is: (a) predictably profitable, and (b) a matched-trade condition exists.

146. The method of paragraph 142, wherein the financial leverage sub-strategies involve constructing a trade to use the leverage process to increase profitability of a trade relative to the original invested amount.

147. The method of paragraph 142, wherein the financial leverage sub-strategies involve subjecting the application of leverage to a standby credit facility agreement that establishes the maximum leverage permitted for the purchase of a particular security, the automatic pledge of the security as collateral, the definition of what constitutes eligible collateral, and the use of the loan proceeds to settle the purchase of eligible securities.

148. The method of paragraph 93, wherein the liquidity sub-strategies involve selling a newly acquired security under the terms of a master repurchase agreement (a repo sale) for the purpose of replenishing liquidity after a permitted security has been acquired for cash, wherein the repo seller is contractually obligated to repurchase the security at the original selling price, plus accrued interest up to the day of the repurchase based on a variable interest rate determined periodically by an inter-bank rate, and the repo seller is obligated to make periodic interest payments to the repo buyer for the use of his funds.

149. The method of paragraph 148, wherein the liquidity sub-strategies involve structuring the repo as an open repo wherein there is no fixed repurchase deadline and the repo can occur at any time up to maturity date of the collateral so long as the repo seller continues to pay periodic interest payments.

150. The method of paragraph 148, wherein the liquidity sub-strategies involve ensuring that the expected liquidity from the repo sale is greater than the cost of the instrument.

151. The method of paragraph 148, wherein the liquidity sub-strategies involve combining the repo sale with a subsequent interest rate swap involving the sale of a contract that delivers periodic variable interest rates in exchange for a fixed interest rate one, wherein this strategy definitively and permanently locks-in the profitability of a trade at the cost of abandoning the upside profitability in the event interest rates decline.

152. The method of paragraph 148, wherein the liquidity sub-strategies involve ensuring excess liquidity is sufficient to pre-fund all of the following reserves and trade execution costs while still providing excess liquidity distributable as pure profit on the trade: (i) the establishment of a cash reserve designed to protect the repo buyer against a loss of value of the collateral in the event interest rates increase and there is a mark-to-market margin call, (ii) the establishment of a stoploss cash reserve wherein the maximum acceptable loss for a particular trade, up to the pre-defined stop-loss limit, secures fully the risk associated with a depreciation of the collateral in the event of an adverse interest rate movement, (iii) the establishment of a hedge that guarantees a non-recourse liquidation of the collateral instrument in a rising interest rate market, wherein consideration paid for the hedge premium guarantees that the stop-loss limit will not be exceeded regardless of market liquidity conditions at the time the liquidation event occurs.

153. The method of paragraph 152, wherein the liquidity sub-strategies involve automatically liquidated collateral by selling it into the market at the point in time when the mark-to-market reserve equals the amount obtained by adding the current market price of the instrument, the total up-to-date amounts of all mark-to-market margin calls, plus the premium charged by the hedge guarantor for the establishment of a non-recourse liquidity guarantee in the event of a liquidation caused by an adverse interest movement resulting in a drop in the value of the collateral.

154. The method of paragraph 152, wherein the liquidity sub-strategies involve pledging the mark-to-market cash reserve to the repo buyer in any form or manner and is fully available to the repo buyer to satisfy any and all mark-to-market collateral margin calls if required.

155. The method of paragraph 152, wherein the liquidity sub-strategies involve requiring the hedge guarantor to assume any and all liquidity risk in the event the automatic liquidation trigger point established by the stop-loss limit is reached, thus fully depleting the mark-to-market reserve set aside.

156. The method of paragraph 152, wherein the liquidity sub-strategies involve requiring the guarantor, as consideration for the premium paid for the hedge, to take on any and all liquidity risks in the event of a forced liquidation and such liquidation is on a non-recourse basis to the repo seller.

157. The method of paragraph 156, wherein the liquidity sub-strategies involve limiting the maximum exposure to the repo seller to the loss of the entire pre-funded mark-to-market reserve set aside, including the cost of the hedge premium.

158. The method of paragraph 152, wherein the liquidity sub-strategies require, in the event of a forced liquidation, that the hedge guarantor acquires the instrument for his own account at a price equal to the stop-loss limit less the premium paid for the establishment of the hedge and immediately reselling it into the market.

159. The method of paragraph 152, wherein the liquidity sub-strategies require, in the event of a forced liquidation, that the hedge guarantor causes the repo buyer to liquidate the instrument at the then current market price and pays for any liquidity shortfall if a loss is incurred.

160. The method of paragraph 152, wherein the liquidity sub-strategies involve in the event the hedge guarantor is also the repo buyer, the repo buyer liquidates the instrument and absorbs any profit or loss on the transaction;

161. The method of paragraph 152, wherein the liquidity sub-strategies allow, in the event of a declining interest rate market, resulting in an increase in the market value of the collateral, under the terms of an “open repo” agreement, that the original seller may at any time repurchase the collateral from the repo buyer at the original price plus accrued interest, and liquidate the security in the market at a profit.

162. The method of paragraph 161, the liquidity sub-strategies allow the repurchase to liberate the lien placed on the mark-to-market reserve and the reserved amount less the cost of the hedge premium is returned to the repo seller, thereby substantially increasing the profitability of the trade for the repo seller.

163. The method of paragraph 161, wherein the liquidity sub-strategies require that the total profit on the trade equals the profit achieved by repurchasing the collateral security from the repo buyer and immediately reselling it into the market at a profit, plus the excess liquidity obtained at the time of the original repo refinancing transaction.

164. The method of paragraph 93, wherein the collateralization and risk management sub-strategies involve minimizing the risk of default in a margin loan agreement through a process of financial engineering involving: (a) an exit strategy that guarantees the rapid intra-day execution of a profitable matched trade so that there is no liquidity drain but an increase in liquidity instead, (b) a settlement process of delivery versus payment (DVP) where the settlement risk is also eliminated; and (c) a simultaneous closing of the buy and resell portions of the transaction.

165. The method of paragraph 164, wherein the collateralization and risk management sub-strategies require that, in the unlikely event of a default, the lender's recourse is, first, against the cash and receivables; second, against the securities held in the portfolio; third, against any mark-to-market reserve set asides that may exist; fourth, against retained earnings.

166. The method of paragraph 93, wherein the collateralization and risk management sub-strategies involve minimizing risk through a trade execution strategy that gives all trade implementation responsibilities to a fiduciary trustee, in which the fiduciary trustee adopts strict investment rules that do not permit the initial investment capital to be depleted.

167. The method of paragraph 93, wherein the collateralization and risk management sub-strategies require that at all times, the balance of cash, plus the securities portfolio (valued at the current mark-to-market price), plus the cash reserves pledged to cover the risk of mark-to-market margin calls, must be equal to or greater than the cumulative exposure to the lender.

168. The method of paragraph 93, wherein the trading strategies and risk management sub-strategies involve addressing liquidity, credit, interest rate, hedging, and settlement risks issues through the adoption of “permitted investment” rules that exist for the purpose of protecting the initial investment principal while guaranteeing a profitable outcome for a trade.

169. The method of paragraph 168, wherein the collateralization and risk management sub-strategies involve utilizing a riskless-principal, matched trade strategy to complete a simultaneous buy-sell trade consisting of the purchase of a security followed by its immediate resale at a profit to a third-party buyer, wherein the sale is final and is on a non-recourse basis to the seller.

170. The method of paragraph 168, wherein the collateralization and risk management sub-strategies involve utilizing a matching a trade to the purchase of a security combined with repo sale, wherein the liquidity obtained from the repo sale is greater than the original cash outlay.

171. The method of paragraph 168, wherein the collateralization and risk management sub-strategies involve using a financial leverage to increase the profitability of a trade if it is accompanied by a hedging strategy that eliminates the downside risk in a profitable matched-trade.

172. The method of paragraph 168, wherein the collateralization and risk management sub-strategies involve utilizing a gains trading strategy for the purpose of enabling the purchase of a security and the subsequent sale of that security at a profit after a short holding period.

173. The method of paragraph 172, wherein the collateralization and risk management sub-strategies involve combining a gains trading strategy with a short-term repo sale of the instrument to a repo buyer.

174. The method of paragraph 173, wherein the collateralization and risk management sub-strategies involve accounting the interest carry cost of the refinancing as an increased cost of the security.

175. The method of paragraph 168, wherein the collateralization and risk management sub-strategies involve permitting repo sale of securities as an exit refinancing strategy designed to replenish liquidity after a permitted security has been acquired with cash.

176. The method of paragraph 168, wherein the collateralization and risk management sub-strategies involve allowing when-issued-securities-trading strategies to facilitate the buying and selling of securities in the period between the announcement of an offering/underwriting and the issuance and payment date of the securities.

177. The method of paragraph 168, wherein the collateralization and risk management sub-strategies involve employing securities-lending strategies to produce additional fee-based income that increases the aggregated yield-to-maturity of a security portfolio, wherein in return for lending its securities, the lender receives a fee, which is quoted as basis points per annum of the original market value of loaned securities.

178. The method of paragraph 168, wherein the collateralization and risk management sub-strategies involve utilizing a pairing-off strategy to enable the buyer to commit to purchase a security and to subsequently pair-off the purchase with a sale of the same security wherein one party to the transaction remits the difference between the purchase and sale price to the counterparty.

179. The method of paragraph 178, wherein the pairing-off strategy also involves the same sequence of events when using interest rate swaps, options on swaps, forward commitments, options on forward commitments, and other derivative contracts.

180. The method of paragraph 168, wherein the collateralization and risk management sub-strategies involve utilizing a hedging-with-derivatives strategy to eliminate risks associated with uncertain events.

181. The method of paragraph 180, wherein the collateralization and risk management sub-strategies involve requiring that a hedge consists of swapping a variable interest rate contract for a fixed rate one to lock-in a fixed interest rate over the expected life of a contract;

182. The method of paragraph 181, wherein the swap is replaced by a swap option that does not immediately lock-in the fixed rate but gives the option holder the right to lock-in the rate at a future date, if desired.

183. The method of paragraph 168, wherein the collateralization and risk management sub-strategies involve utilizing an offsetting-and-netting strategy to net out the present or future payment or delivery obligations or entitlements arising under or in connection with one or more financial contracts entered into by the parties to a master-netting agreement.

184. The method of paragraph 183, wherein the collateralization and risk management sub-strategies involve the offsetting and netting process involves two amounts due under two or more master netting agreements;

185. The method of paragraph 183, wherein the offsetting and netting process involves the determination of any payment or delivery obligations or entitlements under one or more financial contracts entered into under a netting agreement.

186. The method of paragraph 183, wherein the offsetting and netting process involves the acceleration of any payment or delivery obligations or entitlements under one or more financial contracts entered into under a netting agreement.

187. The method of paragraph 183, wherein the offsetting and netting process involves the calculation of one of the following: a close-out value, a market value, a liquidation value; a replacement value in respect of a terminated or accelerated obligation.

188. The method of paragraph 119, wherein the collateralization and risk management sub-strategies involve addressing risk mitigation through the adoption of investment rules and guidelines that exclude certain investment strategies that are deemed to be of a speculative nature and therefore do not fully protect the initial investment principal.

189. The method of paragraph 188, wherein the collateralization and risk management sub-strategies involve requiring that short selling a security for the purpose of speculating that its price will fall over time is not permitted.

190. The method of paragraph 188, wherein the collateralization and risk management sub-strategies require that convergence trading that involves a bet that the price difference between two assets will narrow in the future is not permitted.

200. A system of forming a standardized trust structure, comprising: a trust with an aggregated liquidity pool; a trust agreement that allows the trust to perform pre-selected functions; a subsystem of issuing and redeeming fractional units of ownership in the trust and trust sub-accounts to receive cash and non-cash deposits; a master custody account associated with the trust; a subsystem for issuing trust units to new depositors in exchange for cash and non-cash assets contributed to the trust; a set of permitted investment rules for the aggregated liquidity pool of the trust; a secured loan facility secured by non-cash assets held in the trust; and a subsystem for distributing trust dividends to unit holders.

201. A method comprising:

forming a trust; and

issuing via the trust units of ownership in the trust in exchange for non-cash assets contributed to the trust.

202. The method of claim 201, wherein the units of ownership comprise trust notes.

203. The method of claim 202, wherein the trust notes are discountable for liquid funds.

204. The method of claim 203, and further comprising: aggregating via the trust a pool of illiquid assets.

205. The method of claim 201, and further comprising: earning income via the trust based at least in part on the pool of illiquid assets.

206. The method of claim 205, wherein the pool of illiquid assets includes real estate.

In the preceding description, various aspects of claimed subject matter have been described. For purposes of explanation, specific numbers, systems and/or configurations were set forth to provide a thorough understanding of the claimed subject matter. However, it should be apparent to one skilled in the art having the benefit of this disclosure that claimed subject matter may be practiced without the specific details. In other instances, features that would be understood by one of ordinary skill were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

I claim:

1. A method of forming a standardized trust structure, comprising:
forming a trust by an agreement, with the trust including an aggregated liquidity pool;
constructing the trust agreement to allow the trust to perform preselected functions;
establishing a system of issuing and redeeming fractional units of ownership in the trust;
creating trust sub-accounts to receive cash and non-cash deposits;
opening and maintaining a master custody account for the trust;
issuing trust units to new depositors in exchange for cash and non-cash assets contributed to the trust;
adopting permitted investment rules for the aggregated liquidity pool of the trust;
obtaining a secured loan facility secured by non-cash assets held in the trust; and
distributing trust dividends to unit holders.

2. A method of forming an investment engine for use within by a standardized trust structure, comprising:
constructing and implementing a principal-protected investment mechanism.

3. A method of adopting an investment strategy that complies with permitted investment rules of a trust and simultaneously eliminates risks while increasing return on investment, comprising:
considering plural sub-strategies that include arbitrage trading strategies, overnight sweep strategies, risk mitigation strategies and profit maximization strategies,
eliminating trade execution, credit and liquidity risks in arbitrage trading strategies,
applying financial leverage to increase profitability,
applying refinancing techniques involving repo and reverse repo strategies,
collateralization and risk management strategies; and
including the plural sub-strategies in the investment strategy.

4. A system of forming a standardized trust structure, comprising:
a trust with an aggregated liquidity pool;
a trust agreement that allows the trust to perform pre-selected functions;
a subsystem of issuing and redeeming fractional units of ownership in the trust and trust sub-accounts to receive cash and non-cash deposits;
a master custody account associated with the trust;
a subsystem for issuing trust units to new depositors in exchange for cash and non-cash assets contributed to the trust;
a set of permitted investment rules for the aggregated liquidity pool of the trust;
a secured loan facility secured by non-cash assets held in the trust; and
a subsystem for distributing trust dividends to unit holders.
